(19) United States
(12) Patent Application Publication
(10) Pub. No.: US 2024/0199811 A1
(43) Pub. Date: Jun. 20, 2024

(54) OPTICALLY TRANSPARENT POLYAMIDE-IMIDES

(71) Applicants: ZYMERGEN INC., Emeryville, CA (US); SUMITOMO CHEMICAL COMPANY, LIMITED, Tokyo (JP)

(72) Inventors: Patrick HOMYAK, Oakland, CA (US); Max Benjamin LYONS, Oakland, CA (US); James Ryan PATTON, Emeryville, CA (US); Arjan ZOOMBELT, San Mateo, CA (US); Satoshi OKAMOTO, Tokyo (JP); Kazuya MATSUI, Tokyo (JP); Takashi SAKURAI, Tsukuba, Ibaraki (JP); Takeru SHIMOYAMA, Tsukuba, Ibaraki (JP)

(21) Appl. No.: 18/548,853

(22) PCT Filed: Feb. 28, 2022
(86) PCT No.: PCT/US2022/070866

§ 371 Date: Sep. 1, 2023

Related U.S. Application Data
(60) Provisional application No. 63/157,390, filed on Mar. 5, 2021.

(51) Int. Cl. C08G 73/14; C08J 5/18

(52) U.S. Cl. CPC C08G 73/14; C08J 5/18; C08J 2379/08

(57) ABSTRACT

A polyamide-imide material comprises an amidophenyl-ethyl-imide moiety or alternatively an imidophenyl-ethyl-amide moiety as depicted in formulas (I) or (II) in the disclosure. The polyamide-imide material can have selected mechanical properties, such as a tensile modulus between at least 3.5 GPa and at least 7.8 GPa, a glass transition temperature between at least 180° C. and at least 305° C., an elongation at break of a film of the polyamide-imide material having a thickness of 25 micrometer (±5 micrometer) of not more than 15%, or a folding endurance of the film over a pin having a radius of 1 mm between at least 10,000 folds and at least 1,000,000 folds. The polyamide-imide film can have high transparency of visible light, a low yellow index, and a low haze.

### FIELD OF THE DISCLOSURE

The present disclosure relates to optically transparent polyamide-imides comprising at least one asymmetric di-imido component.

### BACKGROUND

Organic films are high in flexibility as compared to glass, difficult to break, and lightweight. Recently, study has been performed with the aim of developing a flexible display using organic film as the substrate of a flat panel display.

Generally, resins used in organic film include polyester, polyamide, polyimide, polyamide-imide, polycarbonate, polyether sulfone, acrylic, and epoxy. Of these, polyamide-imide resin is high in heat resistance, mechanical strength, abrasion resistance, dimensional stability, chemical resistance, insulation capability, and accordingly in wide use in the electric/electronic industries.

For use as an alternative to the glass substrate in display elements, polyamide-imide resin is required to have high transparency and low birefringence. These properties are necessary to obtain clear images. However, manufacturing methods provide inconsistencies in resins leading to variation in performance properties. Accordingly, there is a need for devising and improving processes that lead to performance consistency.

### SUMMARY

Various aspects and embodiments contemplated herein may include, but are not limited to one or more of the following.

In a first aspect, a polyamide-imide material comprises a moiety of the following formulas:

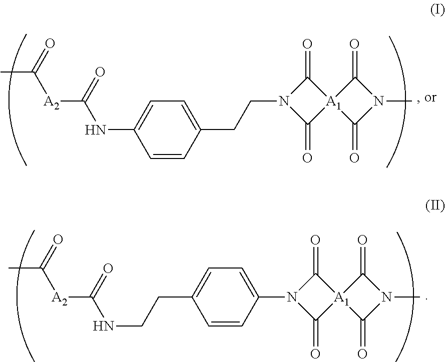

The moiety A₁ is selected from a group of tetravalent moieties. The moiety A₂ can be selected from a group of divalent moieties. The polyamide-imide material has at least one property selected from the following property group M. The polyamide-imide material can have at least one property selected from the following property group O. Property group M can include:
(i) a tensile modulus of the polyamide-imide material as determined according to ASTM standard D638-14 of at least 3.5 GPa, at least 3.8 GPa, at least 4.0 GPa, at least 4.3 GPa, at least 4.5 GPa, at least 4.8 GPa, at least 5.0 GPa, at least 5.3 GPa, at least 5.5 GPa, at least 5.8 GPa, at least 6.0 GPa, at least 6.3 GPa, at least 6.5 GPa, at least 6.8 GPa, at least 7.0 GPa, at least 7.3 GPa, at least 7.5 GPa, or at least 7.8 GPa;
(ii) a glass transition temperature of the polyamide-imide material as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 50 kDa, at least 100 kDa, at least 150 kDa, at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa, or a weight average molecular weight as determined by size exclusion chromatography against a polystyrene standard of at least 50 k, at least 100 k, at least 150 k, or at least 200 k;
(iv) an elongation at break of a film having a thickness of 25 micrometer (±5 micrometer) of the polyamide-imide material as determined by ASTM D638-14 of not more than 15%, not more than 14%, not more than 13%, not more than 12%, not more than 11% , not more than 10%, not more than 9%, not more than 8.5%, not more than 8%, not more than 7.5%, not more than 7%, not more than 6.5%, not more than 6%, not more than 5.5%, not more than 5%, or not more than 4.5%;
(v) a folding endurance of a film having a thickness of 25 micrometer (±5 micrometer) of the polyamide-imide material as determined according to ASTM D2176-16 over a pin having a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds; or
(vi) a compressive modulus of the polyamide-imide material as determined according to ISO 14577-1 of at least 5.0 GPa, at least 5.5 GPa, at least 6.0 GPa, at least 6.5 GPa, at least 7.0 GPa, or at least 7.5 GPa.

Property group O can include:
(i) an optical transparency of a film having a thickness of 25 micrometer (±5 micrometer) of the polyamide-imide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyamide-imide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyamide-imide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) an optical thickness retardation Rₜₕ according to ASTM F218-20 of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASTM E313-20 of a film having a thickness of 25 micrometer (±5 micrometer) of the polyamide-imide material of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze as determined according to ASTM D1003-13 of a film having a thickness of 25 micrometer (±5 micrometer) of the polyamide-imide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

In a second aspect, an optical stack can include a polyamide-imide material according to the first aspect.

In a third aspect, an electronic device can include a polyamide-imide material according to the above first aspect.

In a fourth aspect, a polyamide-imide is made from a first monomer comprising Formula (III):

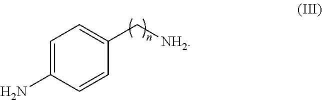

In Formula (III), n can be 1, 2, or 3. The polyamide-imide can be made by at least one second monomer selected from the group consisting of:

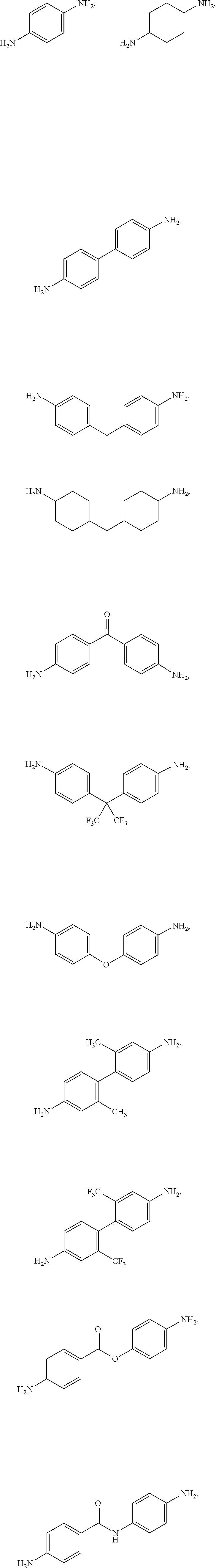

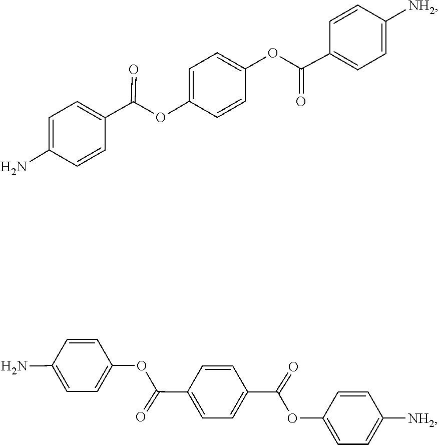 [SMILES: Nc1ccc(C(=O)Oc2ccc(OC(=O)c3ccc(N)cc3)cc2)cc1 ; Nc1ccc(OC(=O)c2ccc(C(=O)Oc3ccc(N)cc3)cc2)cc1]

and any suitable derivatives thereof. The polyamide-imide is further made of at least one tetravalent co-monomer selected from the group consisting of:

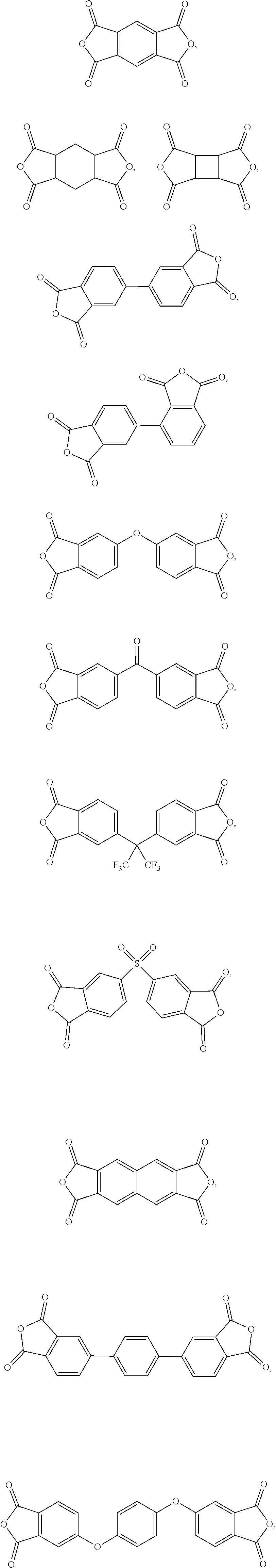

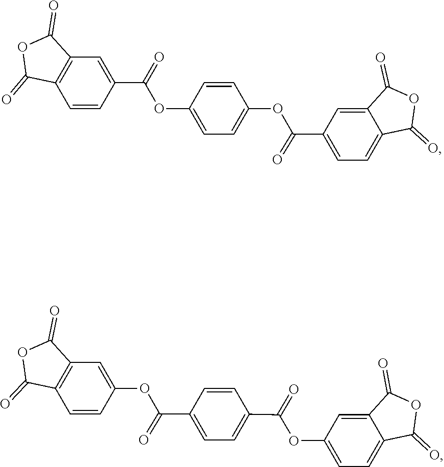 [SMILES: O=C(Oc1ccc(OC(=O)c2ccc3c(c2)C(=O)OC3=O)cc1)c1ccc2c(c1)C(=O)OC2=O ; O=C(Oc1ccc2c(c1)C(=O)OC2=O)c1ccc(C(=O)Oc2ccc3c(c2)C(=O)OC3=O)cc1]

and any suitable derivatives thereof. The polyamide-imide is further made of at least one divalent co-monomer selected from the group consisting of:

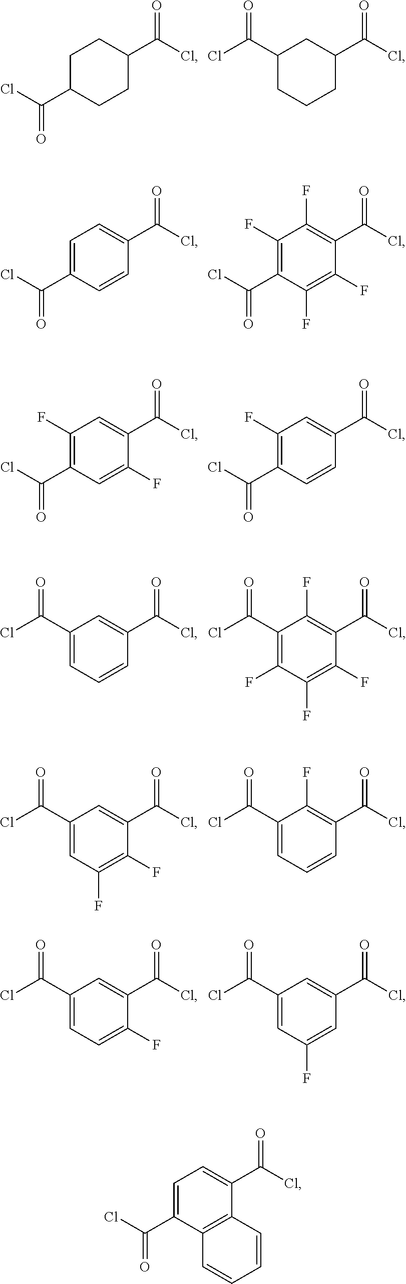

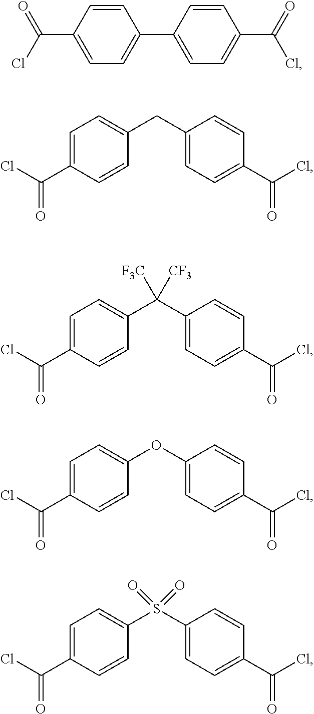 [SMILES: O=C(Cl)c1ccc(-c2ccc(C(=O)Cl)cc2)cc1 ; O=C(Cl)c1ccc(Cc2ccc(C(=O)Cl)cc2)cc1 ; O=C(Cl)c1ccc(C(c2ccc(C(=O)Cl)cc2)(C(F)(F)F)C(F)(F)F)cc1 ; O=C(Cl)c1ccc(Oc2ccc(C(=O)Cl)cc2)cc1 ; O=C(Cl)c1ccc(S(=O)(=O)c2ccc(C(=O)Cl)cc2)cc1]

and any suitable derivative thereof.

In a fifth aspect, a polyamide-imide material comprises the Formula (IV):

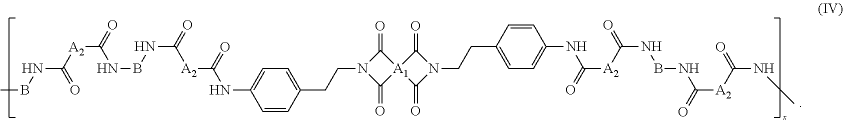

In Formula (IV), A₁ is selected from a group of tetravalent moieties and A₂ is selected from a first group of divalent moieties. B can be selected from a second group of divalent moieties. The parameter x is an integer greater than 1.

### DETAILED DESCRIPTION

The following description is provided to assist in understanding the teachings disclosed herein.

### Definitions

As used herein, the term “any suitable derivative” means any chemical compound capable of producing the same chemical reaction product as the compounds listed in the sentences with the term “any suitable derivative.” For example and without limiting the scope of the present disclosure, if the sentence lists an acid chloride compound A as a co-monomer for the formation of a polyamide-imide, any suitable derivatives are chemical compounds that yield the same polyamide-imide, such as the acid bromide, or an ester derivative of compound A.

As used herein, the term “about” means +/−10% of any recited value. As used herein, this term modifies any recited value, range of values, or endpoints of one or more ranges.

As used herein, the terms “top,” “bottom,” “upper,” “lower,” “above,” and “below” are used to provide a relative relationship between structures. The use of these terms does not indicate or require that a particular structure must be located at a particular location in the apparatus.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt. % to about 5 wt. %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. The order in which activities are listed is not necessarily the order in which they are performed.

In this specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described herein with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

As described above, a polyamide-imide material comprises a moiety of the following formulas:

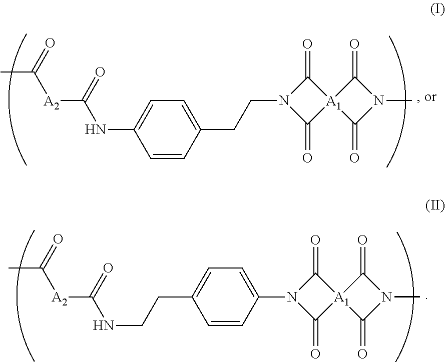

The moiety A₁ is selected from a group of tetravalent moieties. The moiety A₂ can be selected from a group of divalent moieties. The polyamide-imide material has at least one property selected from the following property group M. The polyamide-imide material can have at least one property selected from the following property group O. Property group M can include:
(i) a tensile modulus of the polyamide-imide material as determined according to ASTM standard D638-14 of at least 3.5 GPa, at least 3.8 GPa, at least 4.0 GPa, at least 4.3 GPa, at least 4.5 GPa, at least 4.8 GPa, at least 5.0 GPa, at least 5.3 GPa, at least 5.5 GPa, at least 5.8 GPa, at least 6.0 GPa, at least 6.3 GPa, at least 6.5 GPa, at least 6.8 GPa, at least 7.0 GPa, at least 7.3 GPa, at least 7.5 GPa, or at least 7.8 GPa;
(ii) a glass transition temperature of the polyamide-imide material as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 50 kDa, at least 100 kDa, at least 150 kDa, at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa, or a weight average molecular weight as determined by size exclusion chromatography against a polystyrene standard of at least 50 k, at least 100 k, at least 150 k, or at least 200 k;
(iv) an elongation at break of a film having a thickness of 25 micrometer (±5 micrometer) of the polyamide-imide material as determined by ASTM D638-14 of not more than 15%, not more than 14%, not more than 13%, not more than 12%, not more than 11% , not more than 10%, not more than 9%, not more than 8.5%, not more than 8%, not more than 7.5%, not more than 7%, not more than 6.5%, not more than 6%, not more than 5.5%, not more than 5%, or not more than 4.5%;
(v) a folding endurance of a film having a thickness of 25 micrometer (±5 micrometer) of the polyamide-imide material as determined according to ASTM D2176-16 over a pin having a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds; or
(vi) a compressive modulus of the polyamide-imide material as determined according to ISO 14577-1 of at least 5.0 GPa, at least 5.5 GPa, at least 6.0 GPa, at least 6.5 GPa, at least 7.0 GPa, or at least 7.5 GPa.

Property group O can include:
(i) an optical transparency of a film having a thickness of 25 micrometer (±5 micrometer) of the polyamide-imide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyamide-imide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyamide-imide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) an optical thickness retardation Rₜₕ according to ASTM F218-20 of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASTM E313-20 of a film having a thickness of 25 micrometer (±5 micrometer) of the polyamide-imide material of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze as determined according to ASTM D1003-13 of a film having a thickness of 25 micrometer (±5 micrometer) of the polyamide-imide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

In one embodiment, the polyamide-imide material according to the above first aspect can have the moiety A₁ selected from:

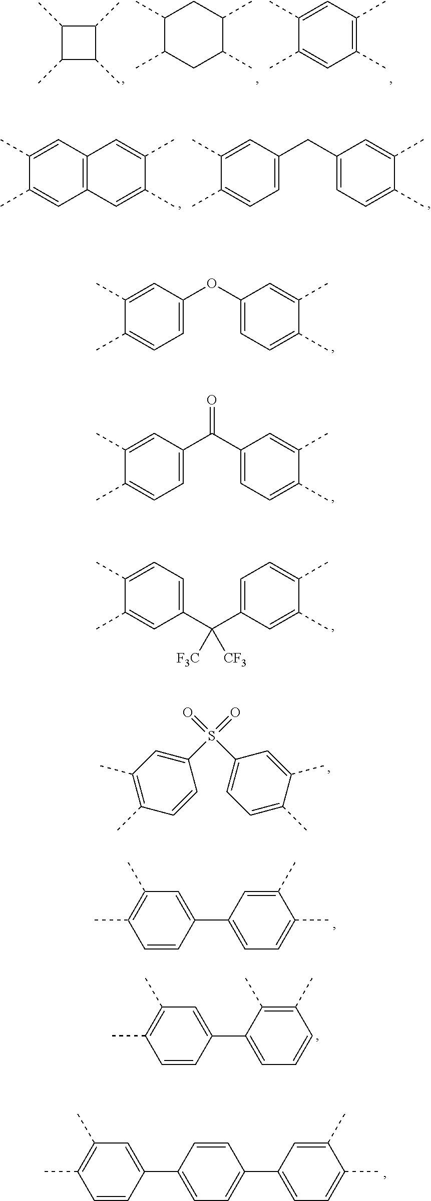

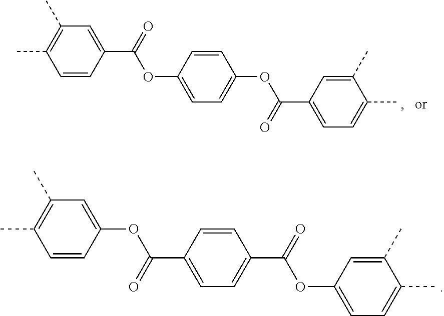

In one further embodiment, the polyamide-imide material according to the first aspect can have moiety A₁ selected from the group consisting essentially of:

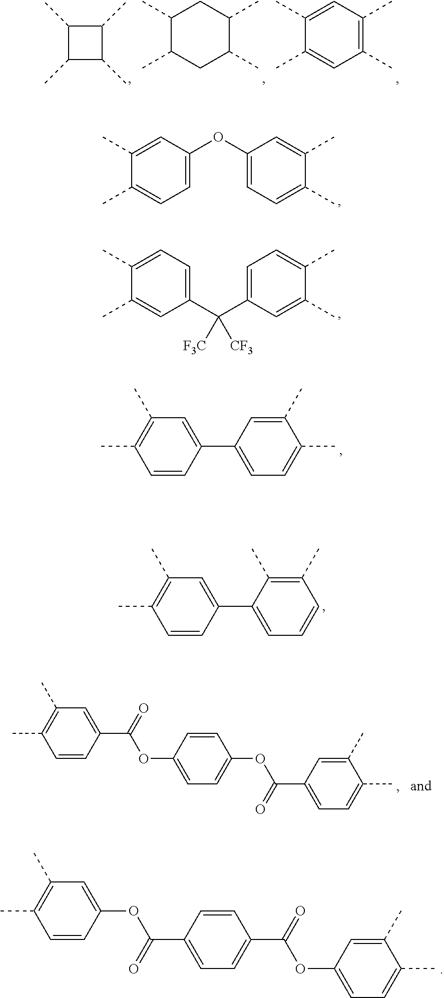

In another embodiment, the polyamide-imide material according to the first aspect can have moiety A₂ selected from:

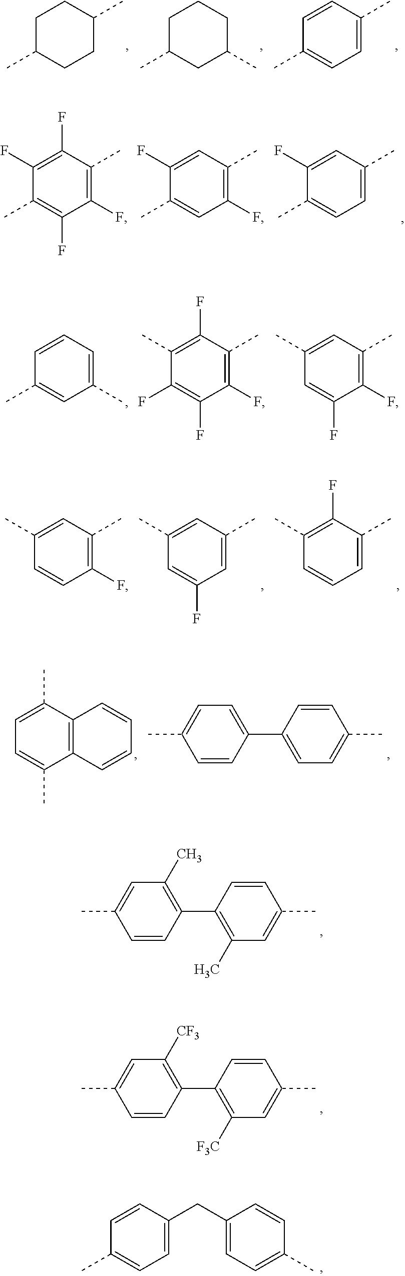

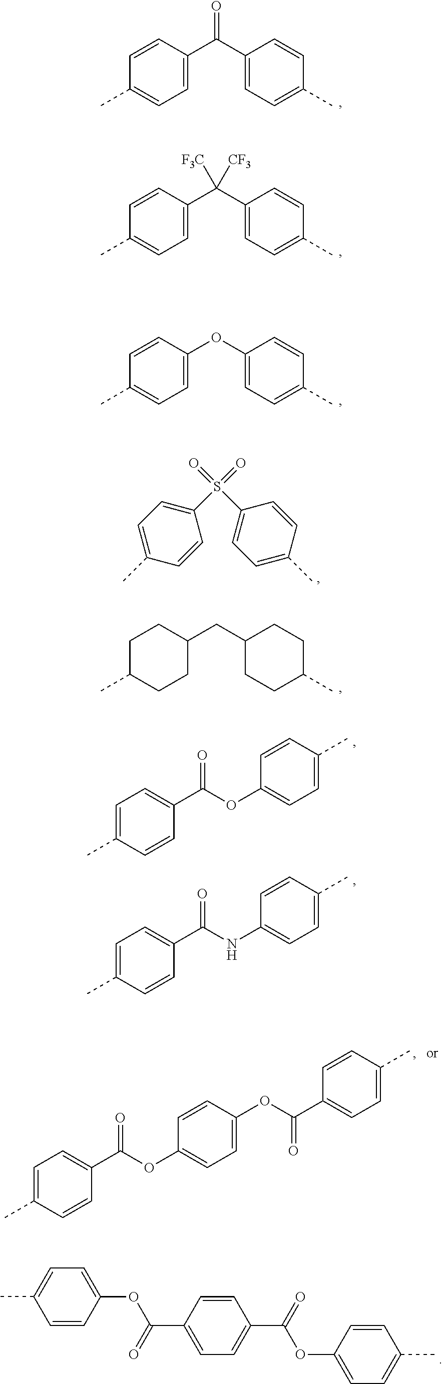

In one further embodiment, A₂ is selected from the group consisting of:

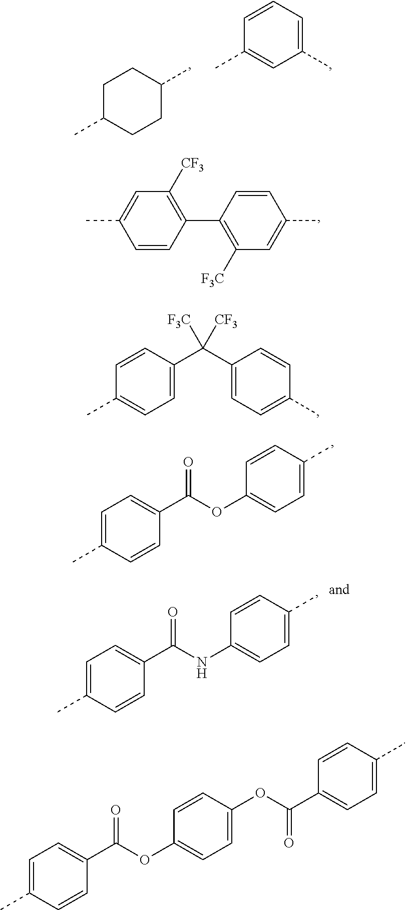

In one embodiment, the polyamide-imide material can have at least two, at least three, or at least four properties of property group M. In another embodiment, the polyamide-imide material can have at least two, at least three, or at least four properties of property group O.

In the aforementioned second aspect, an optical stack can include a polyamide-imide material according to the first aspect or its embodiments. For example, the polyamide-imide material can form a rear or backing layer or a cover layer of the optical stack. In another embodiment, the polyamide-material can be a substrate to the nanocircuitry of an optical stack. In yet another embodiment, the polyamide-imide material can form the horizontal or vertical polarizer of an optical stack or the layers adjacent to the liquid crystal layers. In one further embodiment, the optical stack is an LED or an OLED assembly. The polyamide-imide layer can be a substrate or cover layer of the LED or OLED assembly.

In the aforementioned third aspect, an electronic device includes a polyamide-imide material according to the first aspect. The electronic device can include but is not limited to telephones, cell phones, personal computers, desktop computers, laptops, tablet computers, printers, flatscreen TVs, music players, digital cameras, camcorders, video game consoles, remote controls, smart appliances, automobile control displays, marine and aviation transport control systems.

In the fourth aspect, a polyamide-imide is made from a first monomer comprising Formula (III):

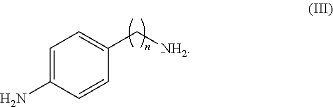

In Formula (III), n can be 1, 2, or 3. The polyamide-imide can be made by at least one second monomer selected from the group consisting of:

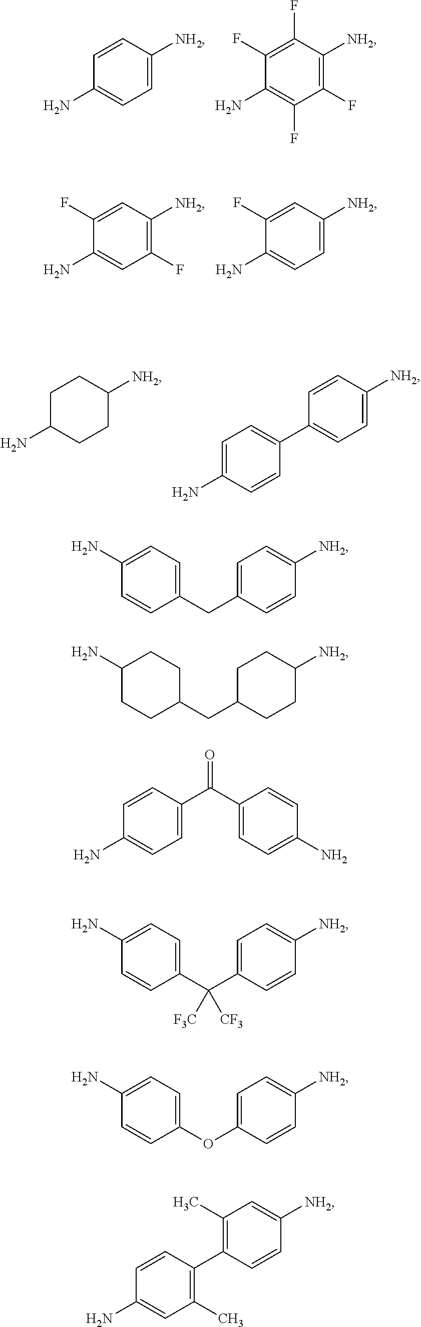

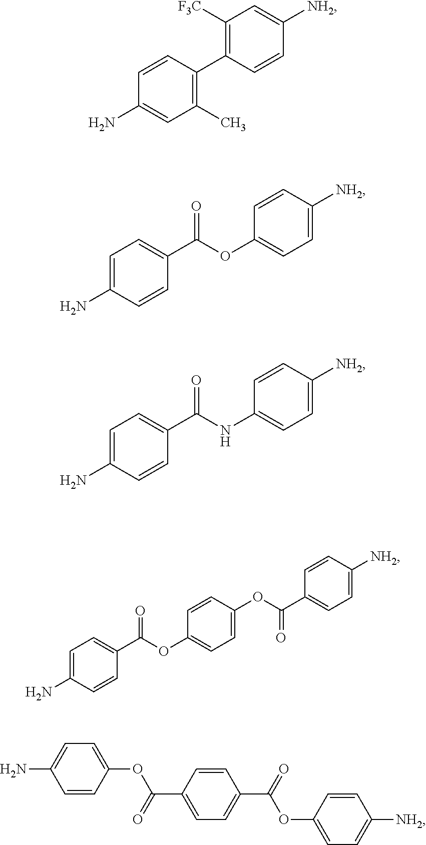 [SMILES: Cc1cc(N)ccc1-c1ccc(N)cc1C(F)(F)F ; Nc1ccc(OC(=O)c2ccc(N)cc2)cc1 ; Nc1ccc(NC(=O)c2ccc(N)cc2)cc1 ; Nc1ccc(C(=O)Oc2ccc(OC(=O)c3ccc(N)cc3)cc2)cc1 ; Nc1ccc(OC(=O)c2ccc(C(=O)Oc3ccc(N)cc3)cc2)cc1]

and any suitable derivatives thereof. The polyamide-imide is further made of at least one tetravalent co-monomer selected from the group consisting of:

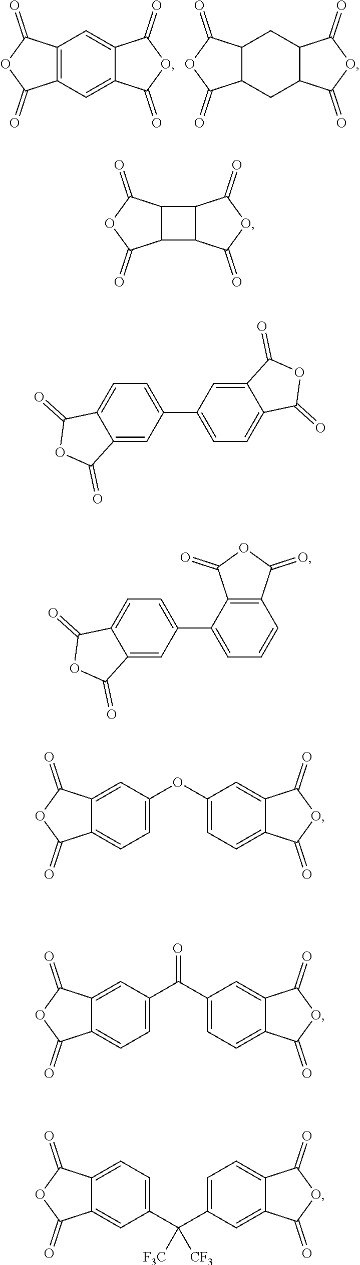

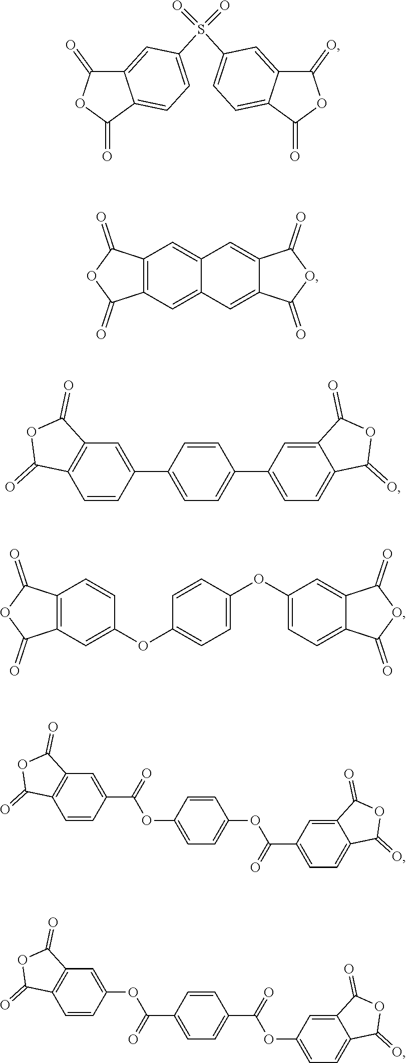 [SMILES: O=C1OC(=O)c2cc(S(=O)(=O)c3ccc4c(c3)C(=O)OC4=O)ccc21 ; O=c1oc(=O)c2cc3cc4c(=O)oc(=O)c4cc3cc12 ; O=C1OC(=O)c2cc(-c3ccc(-c4ccc5c(c4)C(=O)OC5=O)cc3)ccc21 ; O=C1OC(=O)c2cc(Oc3ccc(Oc4ccc5c(c4)C(=O)OC5=O)cc3)ccc21 ; O=C(Oc1ccc(OC(=O)c2ccc3c(c2)C(=O)OC3=O)cc1)c1ccc2c(c1)C(=O)OC2=O ; O=C(Oc1ccc2c(c1)C(=O)OC2=O)c1ccc(C(=O)Oc2ccc3c(c2)C(=O)OC3=O)cc1]

and any suitable derivatives thereof.

The polyamide-imide is further made of at least one divalent co-monomer selected from the group consisting of:

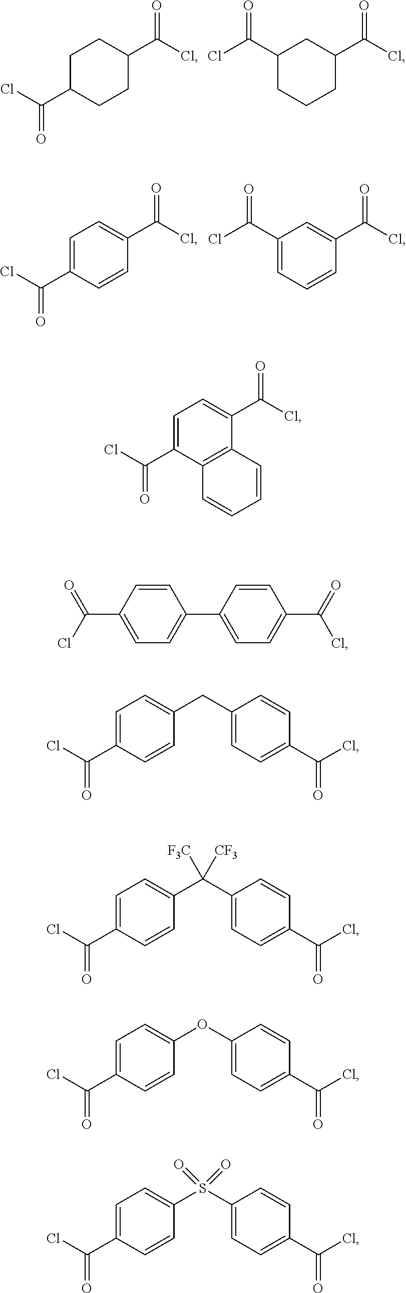

and any suitable derivative thereof.

In one embodiment, the polyamide-imide according to the foregoing fourth aspect can include that the first and the second monomer are in a molar ratio ranging from about 10:1 to about 1:10, such as from about 5:1 to about 1:5, from about 3:1 to about 1:3, from about 2:1 to about 1:2, from about 3:2 to about 2:3, from about 4:3 to about 3:4, from about 5:4 to about 4:5, from about 6:5 to about 5:6, from about 7:6 to about 6:7, from about 8:7 to about 7:8, from about 9:8 to about 8:9, or from about 10:9 to about 9:10.

In yet another embodiment, the polyamide-imide according to the foregoing fourth aspect and embodiments thereof can include that the tetravalent co-monomer and the divalent co-monomer are in a molar ratio ranging from about 10:1 to about 1:10, from about 5:1 to about 1:5, from about 3:1 to about 1:3, from about 2:1 to about 1:2, from about 3:2 to about 2:3, from about 4:3 to about 3:4, from about 5:4 to about 4:5, from about 6:5 to about 5:6, from about 7:6 to about 6:7, from about 8:7 to about 7:8, from about 9:8 to about 8:9, or from about 10:9 to about 9:10.

In one further embodiment, the polyamide-imide according to the foregoing fourth aspect and embodiments thereof can include that the first monomer is 4-aminophenyl-ethyl amine (“APEA”):

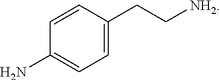

In one other embodiment, the polyamide-imide according to the foregoing fourth aspect and embodiments thereof can include that the tetravalent co-monomer is selected from

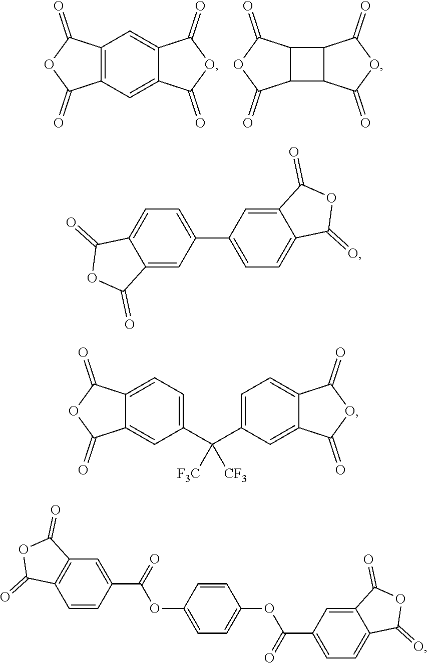

or any suitable derivative thereof. In another embodiment, the divalent co-monomer can be selected from

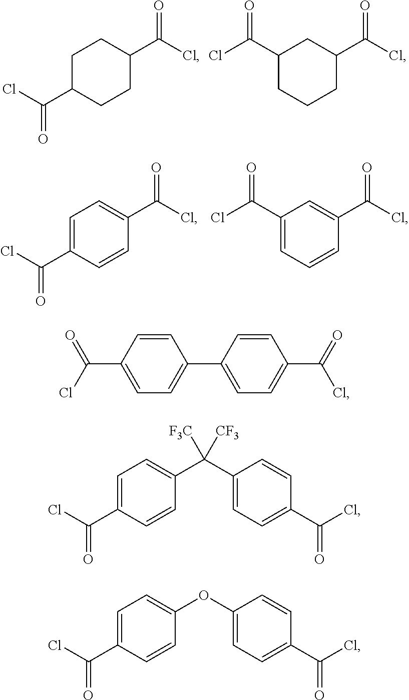

and any suitable derivative thereof.

Moreover, in one embodiment, the polyamide-imide according to the foregoing fourth aspect and embodiments thereof can include that the first monomer is APEA

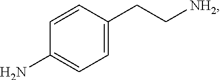

the second monomer is 2,2′-Bis(trifluoromethyl)benzidine (“TFMB”)

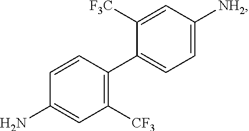 [SMILES: Nc1ccc(-c2ccc(N)cc2C(F)(F)F)c(C(F)(F)F)c1]

the tetravalent co-monomer is 4,4′-(Hexafluoroisopropylidene)diphthalic anhydride (“6FDA”)

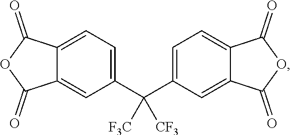 [SMILES: O=C1OC(=O)c2cc(C(c3ccc4c(c3)C(=O)OC4=O)(C(F)(F)F)C(F)(F)F)ccc21]

and the divalent co-monomer is Terephthaloyl chloride (“TPC”)

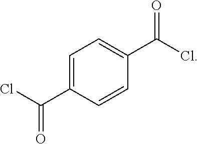 [SMILES: O=C(Cl)c1ccc(C(=O)Cl)cc1]

Furthermore, in one embodiment, the polyamide-imide according to the foregoing fourth aspect and embodiments thereof can include that the first monomer and the second monomer are in a molar ratio ranging from 1:2 to 2:1 and the tetravalent co-monomer to the divalent co-monomer is in a molar ratio of 1:5 to 5:1. In one embodiment the molar ratio of 6FDA:TPC:APEA:TFMB can be selected from the following ratios: 10:90:50:50, 15:85:50:50, 15:85:30:70, 17.5:82.5:35:65, 20:80:50:50, 20:80:60:40, 20:80:30:70, 20:80:40:60, 25:75:25:75, 25:75:50:50, 30:70:60:40, 30:70:80:20.

In the fifth aspect, a polyamide-imide material comprises Formula (IV)

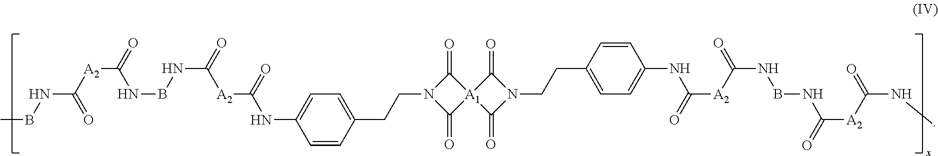

In Formula (IV), A1 is selected from a group of tetravalent moieties. Moiety A2 is selected from a first group of divalent moieties and B is selected from a second group of divalent moieties. Parameter x is an integer that is greater than 1.

In one embodiment, the polyamide-imide material according to the fifth aspect can have at least one property selected from the following property group M. In one embodiment, the polyamide-imide material according to the fifth aspect can have at least one property selected from the following property group O.

Property group M can include:
(i) a tensile modulus of the polyamide-imide material as determined according to ASTM standard D638-14 of at least 3.5 GPa, at least 3.8 GPa, at least 4.0 GPa, at least 4.3 GPa, at least 4.5 GPa, at least 4.8 GPa, at least 5.0 GPa, at least 5.3 GPa, at least 5.5 GPa, at least 5.8 GPa, at least 6.0 GPa, at least 6.3 GPa, at least 6.5 GPa, at least 6.8 GPa, at least 7.0 GPa, at least 7.3 GPa, at least 7.5 GPa, or at least 7.8 GPa;
(ii) a glass transition temperature of the polyamide-imide material as determined by thermomechanical analysis of at least 180° C., at least 185° C., at least 190° C., at least 195° C., at least 200° C., at least 205° C., at least 210° C., at least 215° C., at least 220° C., at least 225° C, at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 50 kDa, at least 100 kDa, at least 150 kDa, at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa, or a weight average molecular weight as determined by size exclusion chromatography against a polystyrene standard of at least 50 k, at least 100 k, at least 150 k, or at least 200 k;
(iv) an elongation at break of a film having a thickness of 25 micrometer (±5 micrometer) of the polyamide-imide material as determined by ASTM D638-14 of not more than 15%, not more than 14%, not more than 13%, not more than 12%, not more than 11%, not more than 10%, not more than 9%, not more than 8.5%, not more than 8%, not more than 7.5%, not more than 7%, not more than 6.5%, not more than 6%, not more than 5.5%, not more than 5%, or not more than 4.5%;
(v) a folding endurance of a film having a thickness of 25 micrometer (±5 micrometer) of the polyamide-imide material as determined according to ASTM D2176-16 over a pin having a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds; or
(vi) a compressive modulus of the polyamide-imide material as determined according to ISO 14577-1 of at least 5.0 GPa, at least 5.5 GPa, at least 6.0 GPa, at least 6.5 GPa, at least 7.0 GPa, or at least 7.5 GPa.

Property group O can include:
(i) an optical transparency of a film having a thickness of 25 micrometer (±5 micrometer) of the polyamide-imide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyamide-imide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyamide-imide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) an optical thickness retardation Rₜₕ according to ASTM F218-20 of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASTM E313-20 of a film having a thickness of 25 micrometer (±5 micrometer) of the polyamide-imide material of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze as determined according to ASTM D1003-13 of a film having a thickness of 25 micrometer (±5 micrometer) of the polyamide-imide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

In one embodiment, the polyamide-imide material according to the fifth aspect can have A₁ selected from:

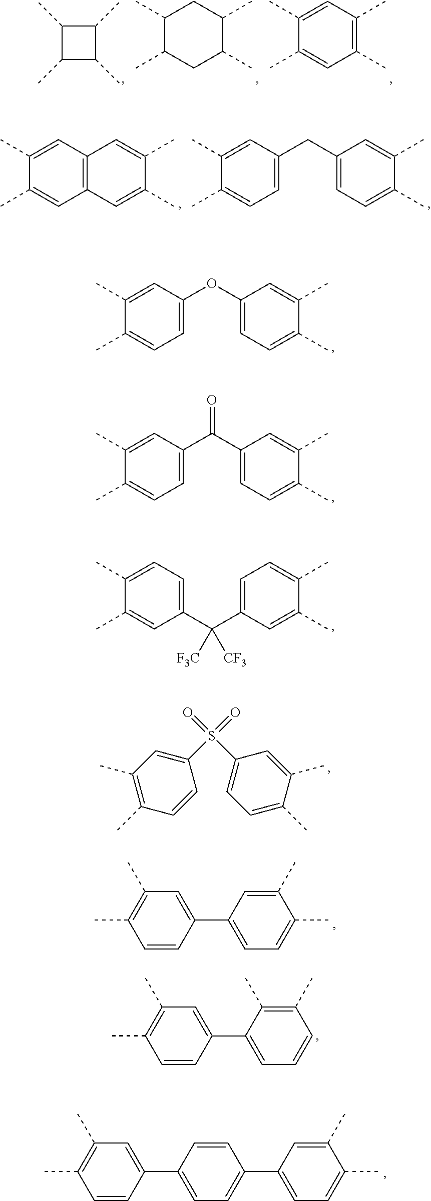

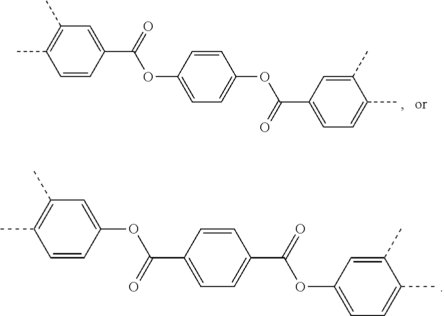

In another embodiment, the polyamide-imide material according to the fifth aspect can have A₂ selected from:

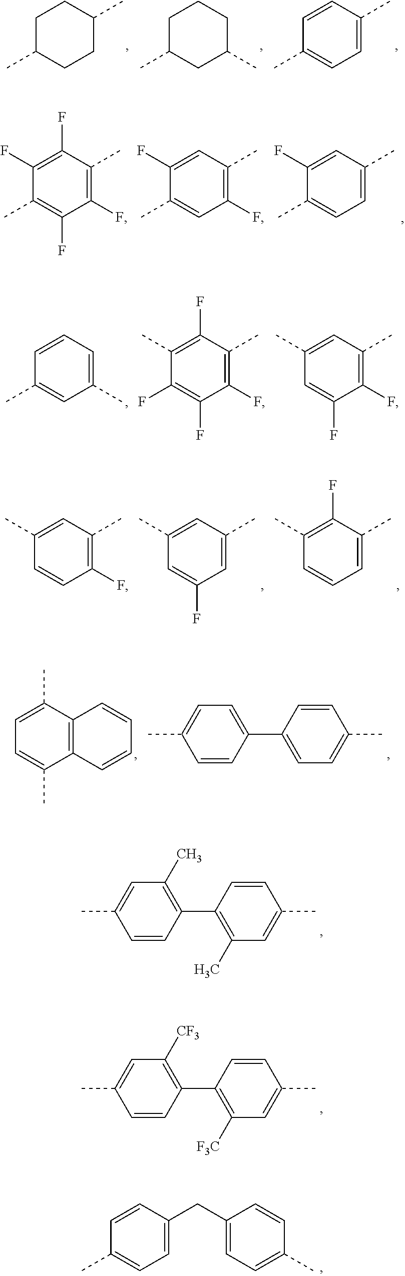

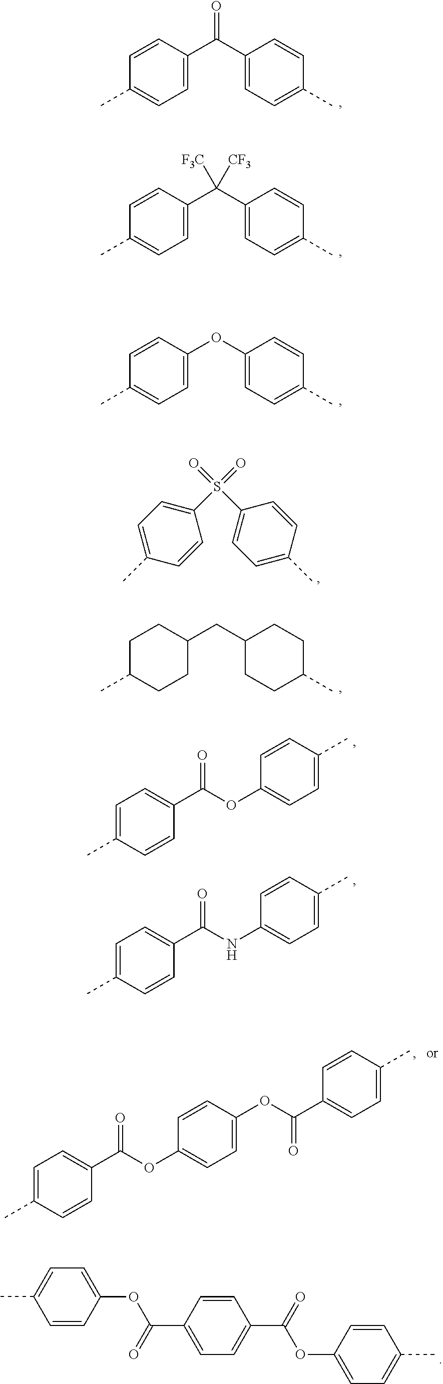

In yet one further embodiment, the polyamide-imide material according to the fifth aspect can have B selected independently for each occasion from:

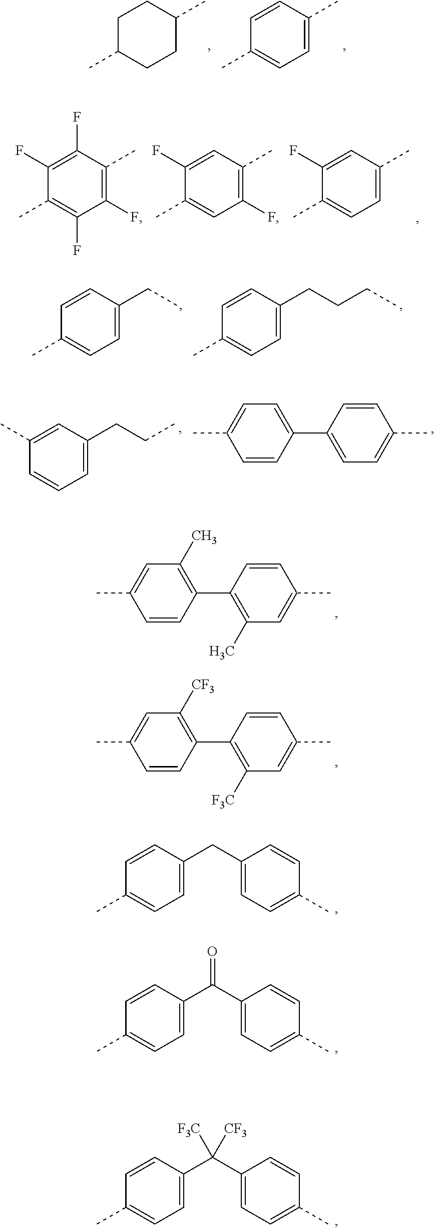

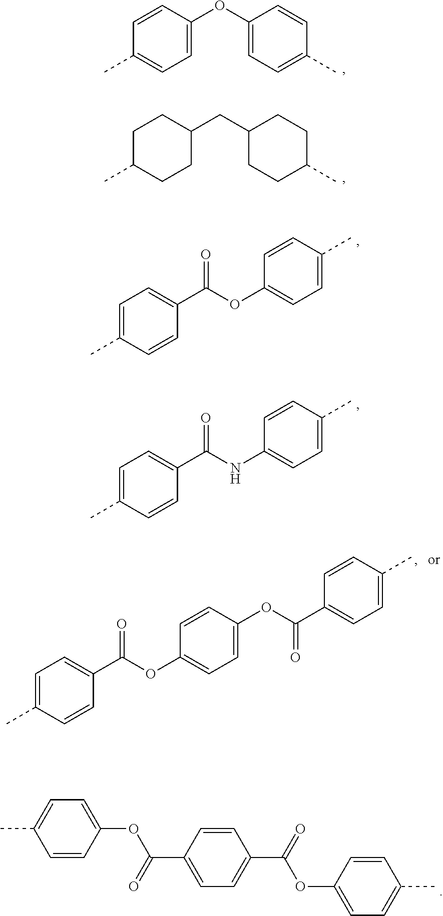

In another embodiment, the polyamide-imide material according to the fifth aspect can have at least two, at least three, or at least four properties of property group M or having at least two, at least three, or at least four properties of property group O.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. A polyamide-imide material including a moiety of Formula (I) or (II):

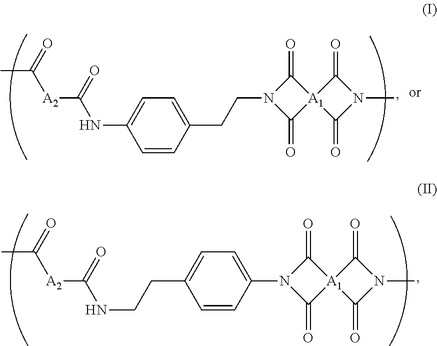

wherein A1 is selected from a group of tetravalent moieties and A2 is selected from a group of divalent moieties; wherein the polyamide-imide material has at least one property selected from the following property group M and at least one property selected from the following property group O, wherein property group M includes:
(i) a tensile modulus of the polyamide-imide material as determined according to ASTM standard D638-14 of at least 3.5 GPa, at least 3.8 GPa, at least 4.0 GPa, at least 4.3 GPa, at least 4.5 GPa, at least 4.8 GPa, at least 5.0 GPa, at least 5.3 GPa, at least 5.5 GPa, at least 5.8 GPa, at least 6.0 GPa, at least 6.3 GPa, at least 6.5 GPa, at least 6.8 GPa, at least 7.0 GPa, at least 7.3 GPa, at least 7.5 GPa, or at least 7.8 GPa;
(ii) a glass transition temperature of the polyamide-imide material as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 50 kDa, at least 100 kDa, at least 150 kDa, at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa, or a weight average molecular weight as determined by size exclusion chromatography against a polystyrene standard of at least 50 k, at least 100 k, at least 150 k, or at least 200 k;
(iv) an elongation at break of a film having a thickness of 25 micrometer (±5 micrometer) of the polyamide-imide material as determined by ASTM D638-14 of not more than 15%, not more than 14%, not more than 13%, not more than 12%, not more than 11%, not more than 10%, not more than 9%, not more than 8.5%, not more than 8%, not more than 7.5%, not more than 7%, not more than 6.5%, not more than 6%, not more than 5.5%, not more than 5%, or not more than 4.5%;
(v) a folding endurance of a film having a thickness of 25 micrometer (±5 micrometer) of the polyamide-imide material as determined according to ASTM D2176-16 over a pin having a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds; or
(vi) a compressive modulus of the polyamide-imide material as determined according to ISO 14577-1 of at least 5.0 GPa, at least 5.5 GPa, at least 6.0 GPa, at least 6.5 GPa, at least 7.0 GPa, or at least 7.5 GPa;
and
property group O includes:
(i) an optical transparency of a film having a thickness of 25 micrometer (±5 micrometer) of the polyamide-imide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyamide-imide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyamide-imide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) an optical thickness retardation Rₜₕ according to ASTM F218-20 of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASTM E313-20 of a film having a thickness of 25 micrometer (±5 micrometer) of the polyamide-imide material of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze as determined according to ASTM D1003-13 of a film having a thickness of 25 micrometer (±5 micrometer) of the polyamide-imide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

Embodiment 2. The polyamide-imide material according to embodiment 1, wherein A₁ is selected from:

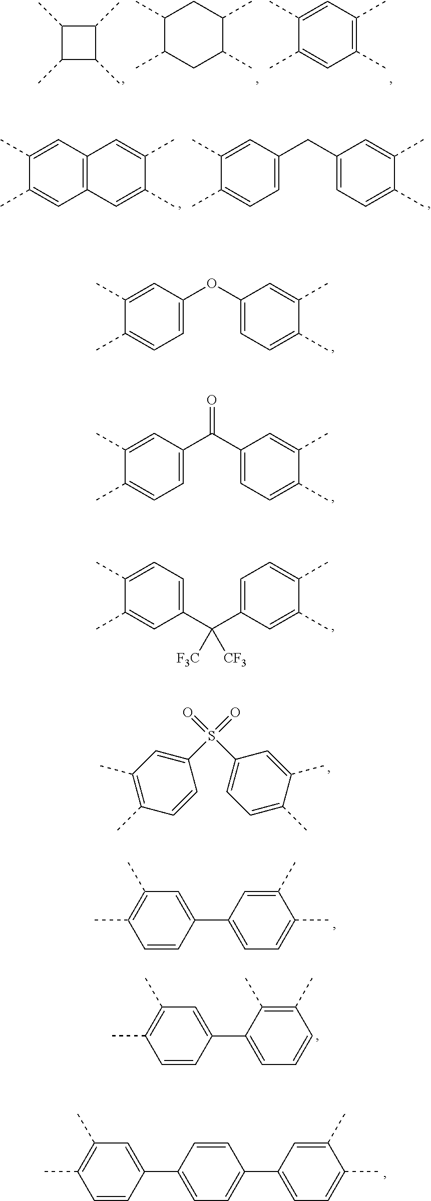

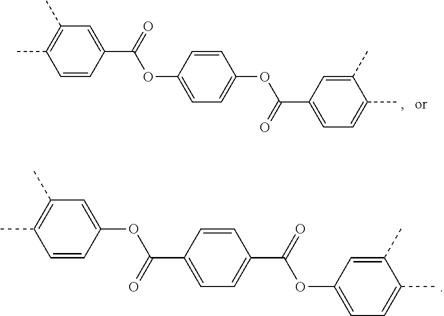

Embodiment 3. The polyamide-imide material according to any one of the preceding embodiments, wherein A₁ is selected from the group consisting essentially of:

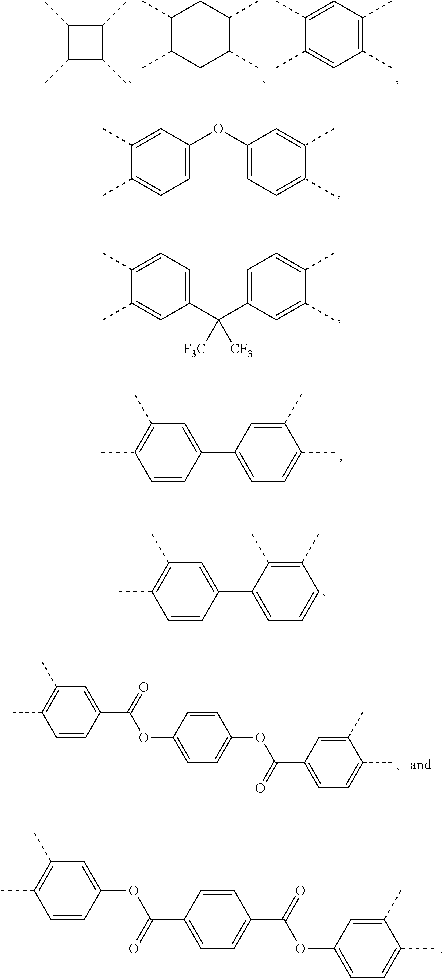

Embodiment 4. The polyamide-imide material according to any one of the preceding embodiments, wherein A₂ is selected from:

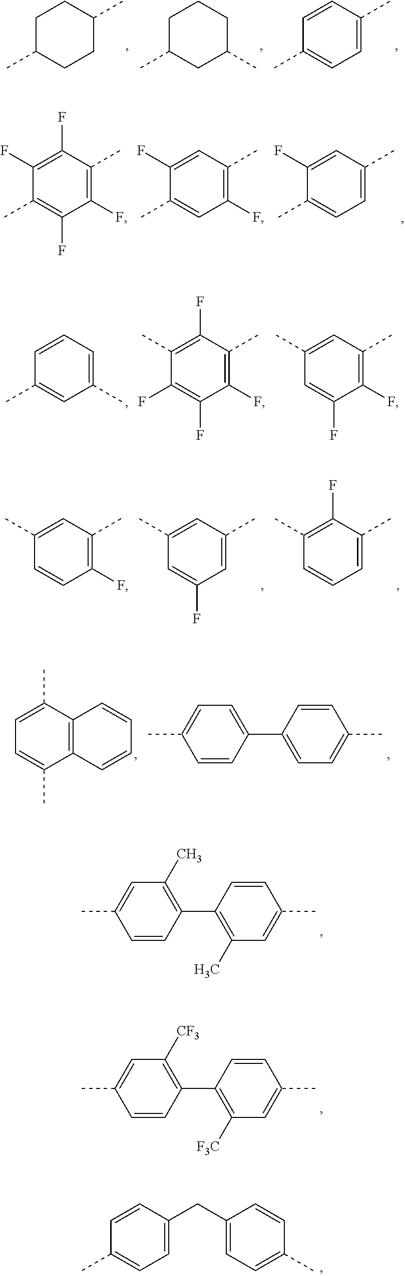

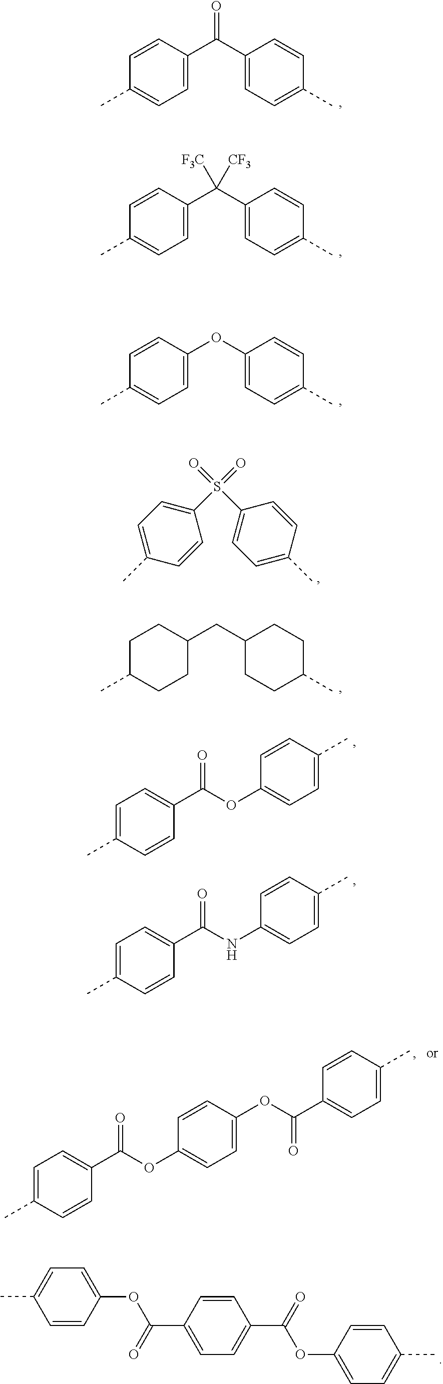

Embodiment 5. The polyamide-imide material according to any one of the preceding embodiments, wherein A₂ is selected from the group consisting of:

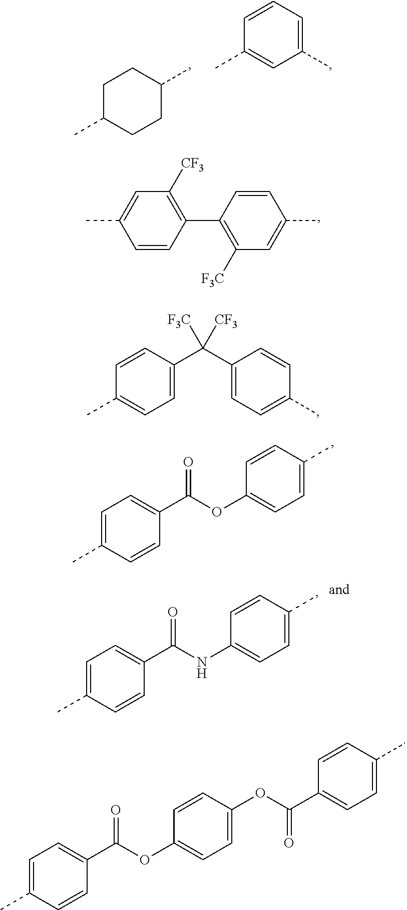

Embodiment 6. The polyamide-imide material according to any one of the preceding embodiments, having at least two, at least three, or at least four properties of property group M.

Embodiment 7. The polyamide-imide material according to any one of the preceding embodiments, having at least two, at least three, or at least four properties of property group O.

Embodiment 8. An optical film comprising a polyamide-imide material according to embodiments 1 through 7.

Embodiment 9. An optical film comprising a polyamide-imide material and filler include inorganic particles according to embodiments 1 through 8.

Embodiment 10. An optical stack comprising a polyamide-imide material according to embodiments 1 through 9.

Embodiment 11. An electronic device comprising a polyamide-imide material according to embodiments 1 through 10.

Embodiment 12. A polyamide-imide made from a first monomer comprising Formula (III):

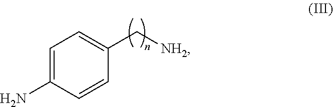

wherein n is 1, 2, or 3; and at least one second monomer selected from the group consisting of

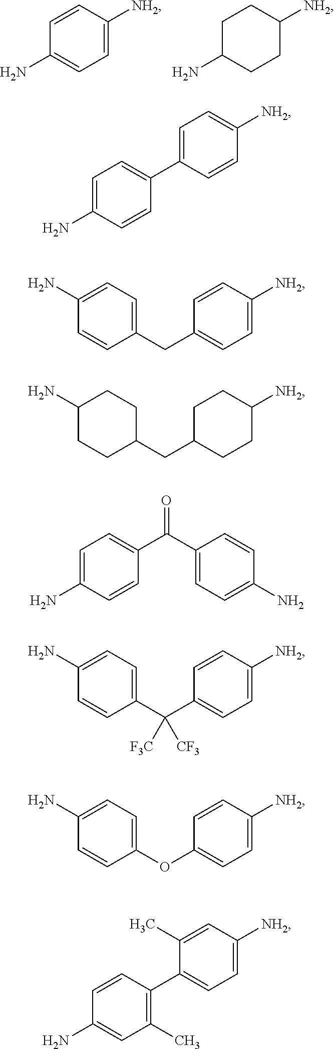

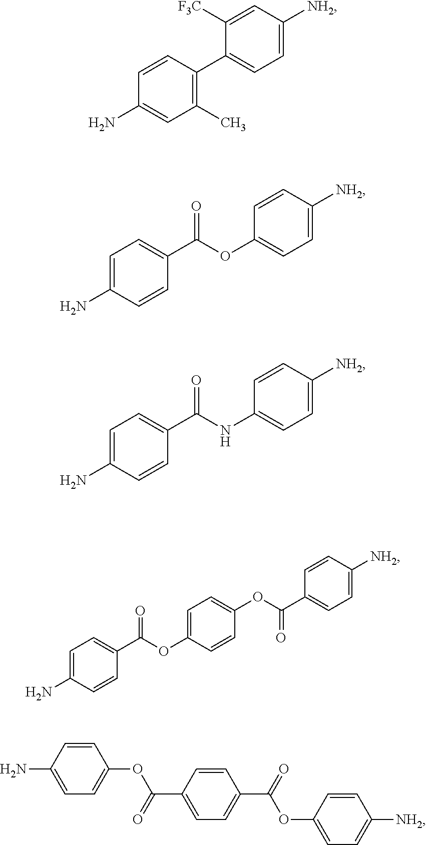 [SMILES: Cc1cc(N)ccc1-c1ccc(N)cc1C(F)(F)F ; Nc1ccc(OC(=O)c2ccc(N)cc2)cc1 ; Nc1ccc(NC(=O)c2ccc(N)cc2)cc1 ; Nc1ccc(C(=O)Oc2ccc(OC(=O)c3ccc(N)cc3)cc2)cc1 ; Nc1ccc(OC(=O)c2ccc(C(=O)Oc3ccc(N)cc3)cc2)cc1]

and any suitable derivatives thereof;
at least one tetravalent co-monomer selected from the group consisting of:

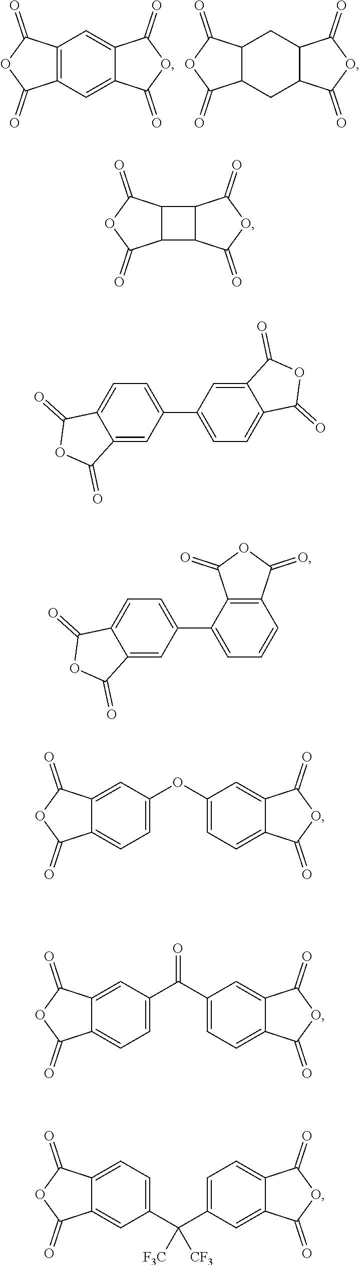

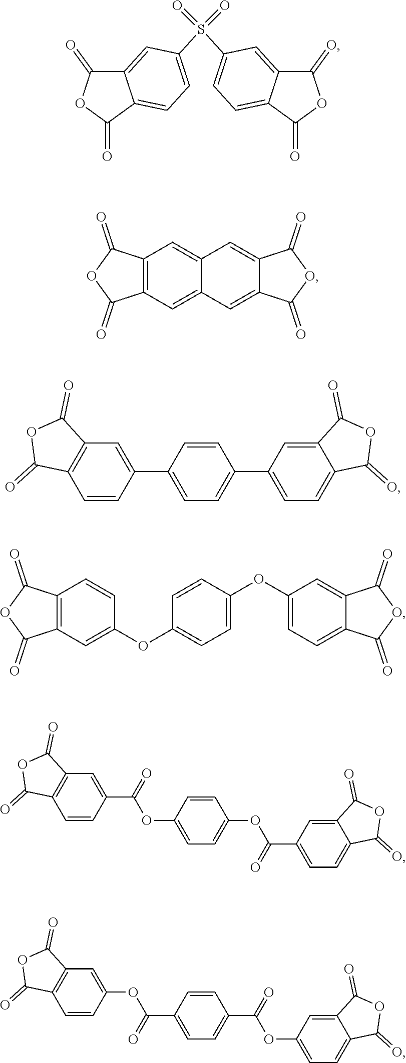 [SMILES: O=C1OC(=O)c2cc(S(=O)(=O)c3ccc4c(c3)C(=O)OC4=O)ccc21 ; O=c1oc(=O)c2cc3cc4c(=O)oc(=O)c4cc3cc12 ; O=C1OC(=O)c2cc(-c3ccc(-c4ccc5c(c4)C(=O)OC5=O)cc3)ccc21 ; O=C1OC(=O)c2cc(Oc3ccc(Oc4ccc5c(c4)C(=O)OC5=O)cc3)ccc21 ; O=C(Oc1ccc(OC(=O)c2ccc3c(c2)C(=O)OC3=O)cc1)c1ccc2c(c1)C(=O)OC2=O ; O=C(Oc1ccc2c(c1)C(=O)OC2=O)c1ccc(C(=O)Oc2ccc3c(c2)C(=O)OC3=O)cc1]

and any suitable derivatives thereof; and
at least one divalent co-monomer selected from the group consisting of:

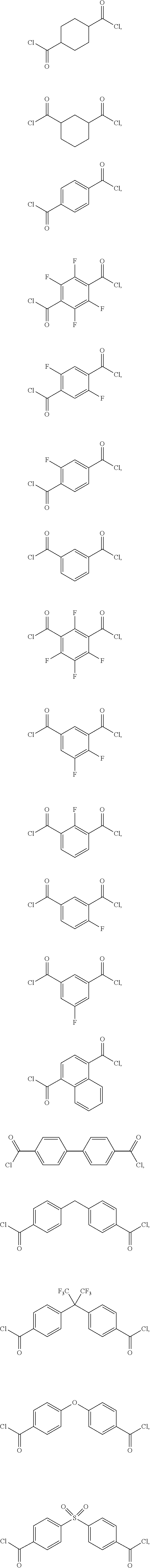

and any suitable derivative thereof.

Embodiment 13. The polyamide-imide according to embodiment 12, wherein the first and the second monomer are in a molar ratio ranging from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

Embodiment 14. The polyamide-imide according to any one of embodiments 12 and 13, wherein the tetravalent co-monomer and the divalent co-monomer are in a molar ratio ranging from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

Embodiment 15. The polyamide-imide according to any one of embodiments 12 to 14, wherein the first monomer is

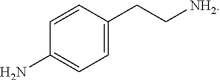

Embodiment 16. The polyamide-imide according to any one of embodiments 12 to 15, wherein the tetravalent co-monomer is selected from

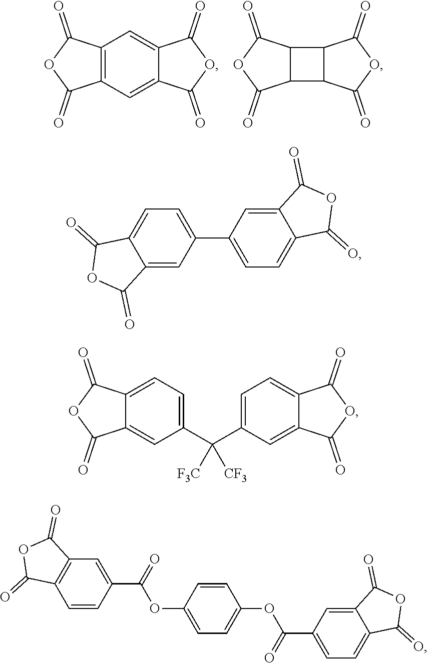

or any suitable derivative thereof;
wherein the divalent co-monomer is selected from

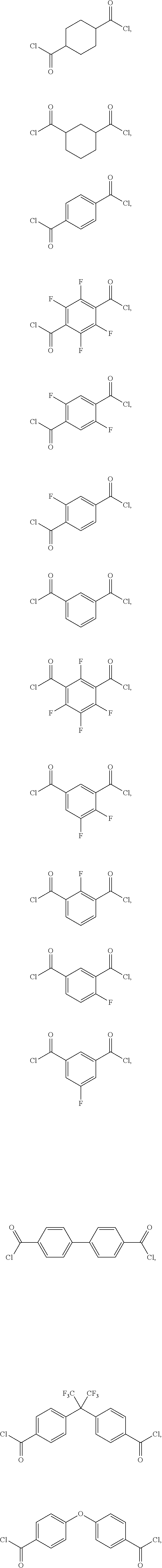

and any suitable derivative thereof.

Embodiment 17. The polyamide-imide according to any one of embodiments 12 to 16, wherein the first monomer is

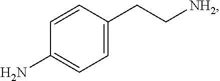

the second monomer is

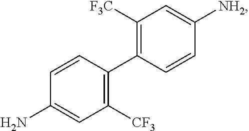 [SMILES: Nc1ccc(-c2ccc(N)cc2C(F)(F)F)c(C(F)(F)F)c1]

the tetravalent co-monomer is

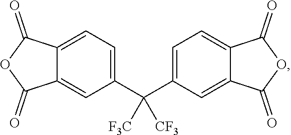 [SMILES: O=C1OC(=O)c2cc(C(c3ccc4c(c3)C(=O)OC4=O)(C(F)(F)F)C(F)(F)F)ccc21]

and the divalent co-monomer is

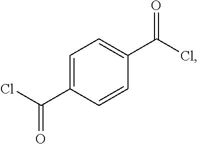 [SMILES: O=C(Cl)c1ccc(C(=O)Cl)cc1]

Embodiment 18. The polyamide-imide according to embodiment 17, wherein the first monomer and the second monomer are in a molar ratio ranging from 1:2 to 2:1 and the tetravalent co-monomer to the divalent co-monomer is in a molar ratio of 1:5 to 5:1.

Embodiment 19. A polyamide-imide material according to Formula (IV)

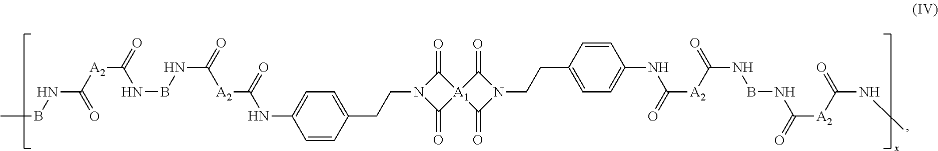

wherein A₁ is selected from a group of tetravalent moieties, A₂ is selected from a first group of divalent moieties and B is selected from a second group of divalent moieties, wherein x is an integer greater than 1.

Embodiment 20. The polyamide-imide material according to embodiment 19, having at least one property selected from the following property group M and at least one property selected from the following property group O, wherein property group M includes:
(i) a tensile modulus of the polyamide-imide material as determined according to ASTM standard D638-14 of at least 3.5 GPa, at least 3.8 GPa, at least 4.0 GPa, at least 4.3 GPa, at least 4.5 GPa, at least 4.8 GPa, at least 5.0 GPa, at least 5.3 GPa, at least 5.5 GPa, at least 5.8 GPa, at least 6.0 GPa, at least 6.3 GPa, at least 6.5 GPa, at least 6.8 GPa, at least 7.0 GPa, at least 7.3 GPa, at least 7.5 GPa, or at least 7.8 GPa;
(ii) a glass transition temperature of the polyamide-imide material as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 50 kDa, at least 100 kDa, at least 150 kDa, at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa, or a weight average molecular weight as determined by size exclusion chromatography against a polystyrene standard of at least 50 k, at least 100 k, at least 150 k, or at least 200 k;
(iv) an elongation at break of a film having a thickness of 25 micrometer (±5 micrometer) of the polyamide-imide material as determined by ASTM D638-14 of not more than 15%, not more than 14%, not more than 13%, not more than 12%, not more than 11, not more than 10%, not more than 9%, not more than 8.5%, not more than 8%, not more than 7.5%, not more than 7%, not more than 6.5%, not more than 6%, not more than 5.5%, not more than 5%, or not more than 4.5%;
(v) a folding endurance of a film having a thickness of 25 micrometer (±5 micrometer) of the polyamide-imide material as determined according to ASTM D2176-16 over a pin having a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds; or
(vi) a compressive modulus of the polyamide-imide material as determined according to ISO 14577-1 of at least 5.0 GPa, at least 5.5 GPa, at least 6.0 GPa, at least 6.5 GPa, at least 7.0 GPa, or at least 7.5 GPa;
and
property group O includes:
(i) an optical transparency of a film having a thickness of 25 micrometer (±5 micrometer) of the polyamide-imide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyamide-imide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyamide-imide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) an optical thickness retardation Rₜₕ according to ASTM F218-20 of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASTM E313-20 of a film having a thickness of 25 micrometer (±5 micrometer) of the polyamide-imide material of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze as determined according to ASTM D1003-13 of a film having a thickness of 25 micrometer (±5 micrometer) of the polyamide-imide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

Embodiment 21. The polyamide-imide material according to any one of embodiments 19 and 20, wherein A₁ is selected from:

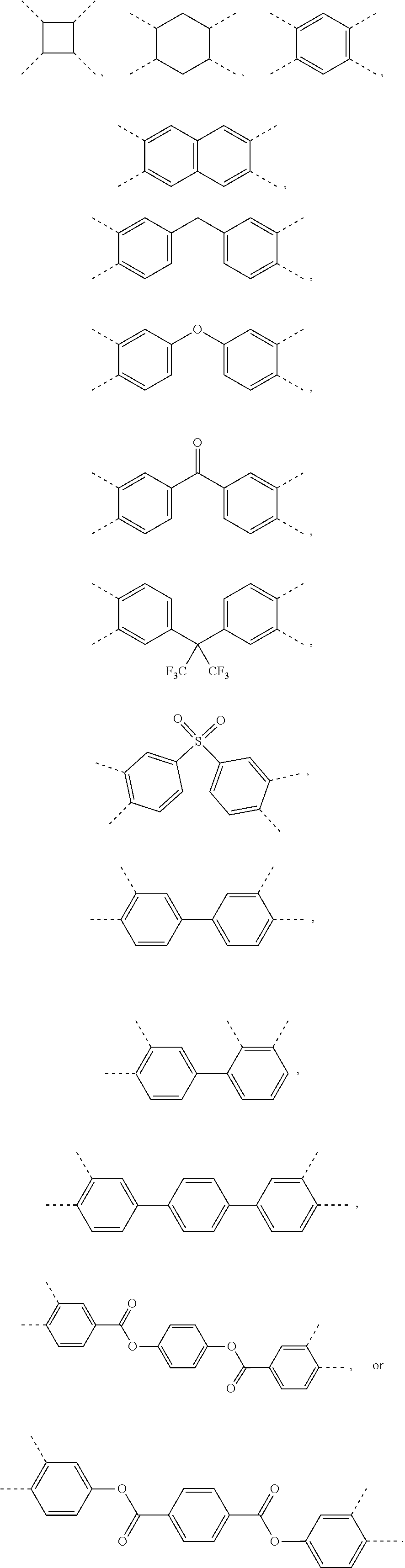

Embodiment 22. The polyamide-imide material according to any one of embodiments 19 through 21, wherein A₂ is selected from:

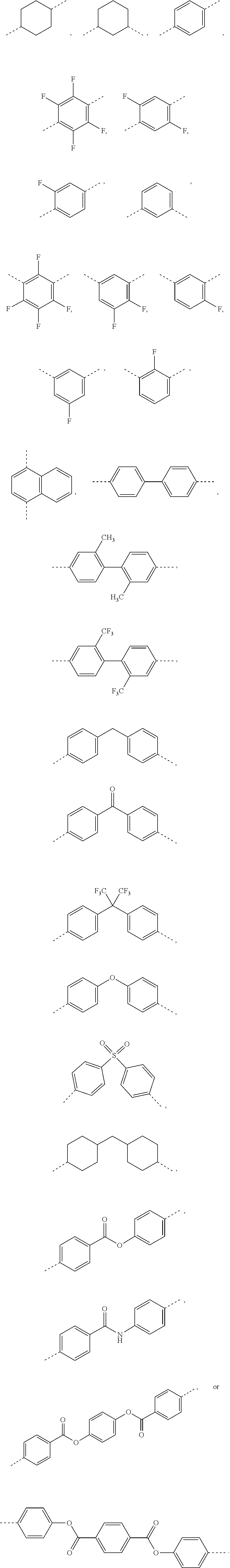

Embodiment 23. The polyamide-imide material according to any one of embodiments 19 through 22, wherein B is selected independently for each occasion from:

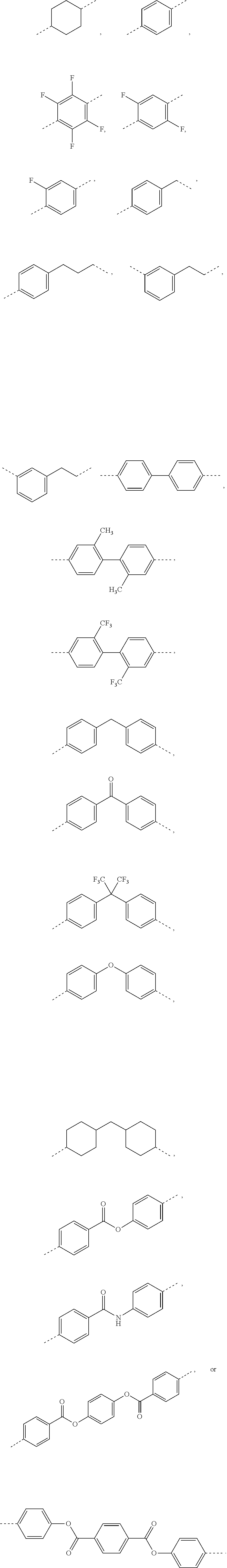

Embodiment 24. The polyamide-imide material according to any one of embodiments 19 through 23 having at least two, at least three, or at least four properties of property group M or having at least two, at least three, or at least four properties of property group O.

In one embodiment of the present invention, the optical film of the present invention may contain an ultraviolet absorber. Since the optical film of the present invention contains the polyamide-imide resin, it is excellent in mechanical properties and heat resistance in addition to low phase difference, low haze and low yellowness even if it contains an ultraviolet absorber. Therefore, by using an ultraviolet absorber to reduce the light absorption in the ultraviolet region, ultraviolet cut property, low phase difference, transparency, mechanical properties and heat resistance can be exhibited in a well-balanced manner. Examples of the ultraviolet absorber include a triazine derivative (triazine-based ultraviolet absorber) such as a benzotriazole derivative (benzotriazole-based ultraviolet absorber) and a 1,3,5-triphenyltriazine derivative, a benzophenone derivative (benzophenone-based ultraviolet absorber), a salicylate derivative (salicylate-based ultraviolet absorber), and at least one selected from the group composed of these can be used. A benzotriazole-based UV absorber that has UV absorption in the vicinity of 300 to 400 nm, such as 320 to 360 nm, can improve the UV cut property of the optical film without lowering the transmittance in the visible light region. In a particular embodiment, the ultraviolet absorber is at least one selected from the group composed of the triazine-based ultraviolet absorber and the benzotriazole-based ultraviolet absorber. In a more particular embodiment, the ultraviolet absorber is the benzotriazole-based ultraviolet absorber.

Specific examples of the benzotriazole-based ultraviolet absorber include a compound represented by trade name manufactured by Sumitomo Chemical Co., Ltd.: Sumisorb® 250 (2-[2-hydroxy-3-(3)., 4,5,6-tetrahydrophthalimide-methodiyl)-5-methylphenyl]benzotriazole), manufactured by BASF Japan Co., Ltd. Trade name: Tinuvin® 360 (2,2′-methylenebis[6-(2H)-Benzotriazole-2-yl)-4-tert-octylphenol]) and Tinuvin 213 (methyl3-[3-(2H-benzotriazole-2-yl)5-tert-butyl-4-hydroxyphenyl]propionate and PEG300 (Reaction products with), and these can be used alone or in combination of two or more. Specific examples of the compound represented by the formula (I) include trade names manufactured by Sumitomo Chemical Co., Ltd.: Sumisorb 200 (2-(2-hydroxy-5-methylphenyl)benzotriazole), Sumisorb 300 (2-(3).-tert-Butyl-2-hydroxy-5-methylphenyl)-5-chlorobenzotriazole), Sumisorb 340 (2-(2-hydroxy-5-tert-octylphenyl) benzotriazole), Sumisorb 350 (2-(2)-Hydroxy3,5-di-tert-pentylphenyl)benzotriazole), and BASF Japan Co., Ltd. trade name: Tinuvin 327 (2-(2′-hydroxy-3′,5′-di-tert-butyl)Phenyl)-5-chlorobenzotriazole), Tinuvin 571 (2-(2H-benzotriazo-2-yl)-6-dodecyl-4-methyl-phenol) and Tinuvin 234 (2-(2H-benzotriazole-2-yl)))-4,6-bis(1-methyl-1-phenylethyl)phenol) and ADEKA Co., Ltd. Product name: Adecastab® LA-31 (2,2′-methylenebis[6-(2H-benzo Triazole-2-yl)-4-(1,1,3,3-tetramethylbutyl)phenol]) can be mentioned. In an embodiment, the UV absorber is a compound represented by the formula (I) and Tinuvin 213 (methyl3-[3-(2H-benzotriazole-2-yl)5-tert-butyl-4-hydroxyphenyl] propionate. It is a reaction product with PEG300, more particularly a trade name manufactured by Sumitomo Chemical Co., Ltd.: Sumisorb 200 (2-(2-hydroxy-5-methylphenyl)benzotriazole), Sumisorb 300 (2-(3-tert).-Butyl-2-hydroxy-5-methylphenyl)-5-chlorobenzotriazole), Sumisorb 340 (2-(2-hydroxy-5-tert-octylphenyl)benzotriazole), Sumisorb 350 (2-(2-hydroxy)3,5-Di-tert-Pentylphenyl)benzotriazole), Product name of ADEKA Co., Ltd.: Adecastab LA-31 (2,2′-methylenebis[6-(2H-benzotriazole-2-yl)-4-(1,1,3,3-tetramethylbutyl)phenol]) and BASF Japan Co., Ltd. trade name: Tinuvin 327 (2-(2′-hydroxy-3′,5′-di-tert-butylphenyl))-5-Chlorobenzotriazole) and Tinuvin 571 (2-(2H-benzotriazo-2-yl)-6-dodecyl-4-methyl-phenol), most particularly the trade name of Sumitomo Chemical Co., Ltd.: Sumisorb 340 (2-(2-hydroxy-5-tert-octylphenyl)benzotriazole), Sumisorb350 (2-(2-hydroxy3,5-di-tert-pentylphenyl)benzotriazole), and ADEKA Co., Ltd. Product name: Adecastab LA-31 (2,2′-methylenebis[6-(2H-benzotriazol-2-yl)-4-(1,1,3,3-tetramethylbutyl)phenol]).

As the ultraviolet absorber according to another embodiment, a triazine-based ultraviolet absorber is used in an optical film containing a polyamide-imide based resin. As a specific example, the product name of ADEKA Co., Ltd.: Adecastab LA-46 (2-(4,6-diphenyl-1,3,5-triazine-2-yl)-5-[2-(2-ethyl)Hexancuroxy)ethoxy]phenol), trade name manufactured by BASF Japan Co., Ltd.: Tinuvin 400 (2-[4-[2-hydroxy-3-tridecyloxypropyl]oxy]-2-hydroxyphenyl]-4,6-Bis(2,4-dimethylphenyl)- 1,3,5-triazine), 2-[4-[2-hydroxy-3-didecyloxypropyl]oxy]-2-hydroxyphenyl]-4,6-bis(2,4-Dimethylphenyl)-1,3,5-Triazine), Tinuvin 405 (2-[4 (2-hydroxy-3-(2′-ethyl)hexyl)oxy]-2-hydroxyphenyl]-4,6-bis(2,4-dimethylphenyl)-1,3,5-triazine), Tinuvin 460 (2,4-bis(2-hydroxy-4-butyloxyphenyl)-6-(2,4-bis)-Butyloxyphenyl)-1,3,5-triazine), Tinuvin 479 (hydroxyphenyltriazine-based ultraviolet absorber), and Chemipro Kasei Co., Ltd. Product name: KEMISORB® 102 (2-[4,6)-Bis(2,4-dimethylphenyl)-1,3,5-triazine-2-yl]-5-(n-octyloxy)phenol), etc., may be used alone or in combination of two or more.

In a particular embodiment, the ultraviolet absorber has a light absorption of 300 to 400 nm, such as a light absorption of 320 to 360 nm, and in a more particular embodiment, has a light absorption of around 350 nm.

When the optical film of the present invention contains ultraviolet absorption, the content of the ultraviolet absorber is 0.1 part by mass or more, such as 0.5 part by mass or more, and even 0.8 with respect to 100 parts by mass of the polyamide-imide resin. Content of the ultraviolet absorber is by mass or more, particularly 1 part by mass or more, such as 10 parts by mass or less, such as 8 parts by mass or less, and even 5 parts by mass or less.

The optical film of the present invention may contain at least one filler. The inclusion of a filler tends to enhance the optical properties, heat resistance and mechanical properties of the optical film. Examples of the filler include organic particles and inorganic particles, and in a particular embodiment, inorganic particles. Examples of inorganic particles include silica, titania, zinc oxide, germanium oxide, indium oxide, tin oxide, Indium Tin Oxide (ITO), antimony oxide, and cerium oxide, magnesium fluoride, and fluoride. Examples thereof include metal fluoride particles such as sodium chemicals, and among these, silica particles are particularly desirable from the viewpoint of easily having a good balance of optical properties, heat resistance, and mechanical properties of the optical film. In a particular embodiment, the filler includes silica particles. These fillers can be used alone or in combination of two or more.

The average primary particle size of the filler, such as silica particles, is usually 1 nm or more, such as 5 nm or more, such as 10 nm or more, such as 15 nm or more, such as 20 nm or more, and even 100 nm or less. In an embodiment, the average primary particle size of the filler is 80 nm or less, such as 60 nm or less, or even 40 nm or less. When the average primary particle size of the silica particles is within the above range, the aggregation of the silica particles is suppressed, and the optical properties, heat resistance and mechanical properties of the obtained optical film can be easily improved. The average primary particle size of the filler can be measured by the BET method. The average primary particle size may be measured by image analysis of a transmission electron microscope or a scanning electron microscope.

When the optical film of the present invention contains a filler, such as silica particles, the content of the filler is usually 0.1% by mass or more, such as 1% by mass or more, such as 5% by mass, based on the mass of the optical film. As mentioned above and in an embodiment, the content of the filler is 10% by mass or more, such as 60% by mass or less, such as 50% by mass or less, such as 40% by mass or less. When the content of the filler is within the above range, the optical properties, heat resistance and mechanical properties of the optical film can be easily improved.

The optical film of the present invention may further contain additives other than the ultraviolet absorber and the filler. Examples of other additives include antioxidants, mold release agents, stabilizers, brewing agents, flame retardants, pH regulators, silica dispersants, lubricants, thickeners, leveling agents and the like. When other additives are present, the content thereof is typically 0.001 to 20% by mass, such as 0.01 to 15% by mass, such as 0.1 to 10% by mass, based on the mass of the optical film.

The application of the optical film of the present invention is not particularly limited, and is used for various applications such as a substrate for a touch sensor, a material for a flexible display device, a protective film, a film for bezel printing, a semiconductor application, a speaker diaphragm, an IR cut filter, and the like. As described above, the optical film of the present invention may be a single layer or a laminated body, the optical film of the present invention may be used as it is, or a laminated body with another film. When the optical film is a laminated body, it is referred to as an optical film including all the layers laminated on one side or both sides of the optical film.

When the optical film of the present invention is a laminated body, one or more functional layers may be present on at least one surface of the optical film. Examples of the functional layer include a hard coat layer, a primer layer, a gas barrier layer, an ultraviolet absorbing layer, an adhesive layer, a hue adjusting layer, and a refractive index adjusting layer. The functional layer can be used alone or in combination of two or more.

In one embodiment of the present invention, the optical film may have a protective film on at least one side (one side or both sides). For example, when the functional layer is provided on one side of the optical film, the protective film may be laminated on the surface on the optical film side or the surface on the functional layer side, and is laminated on both the optical film side and the functional layer side. When the optical film has functional layers on both sides, the protective film may be laminated on the surface on one functional layer side or on the surfaces on both functional layer sides. The protective film is a film for temporarily protecting the surface of the optical film or the functional layer, and is not particularly limited as long as it is a peelable film capable of protecting the surface of the optical film or the functional layer. Examples of the protective film include polyester resin films such as polyethylene terephthalate, polybutylene terephthalate, and polyethylene naphthalate; polyolefin resin films such as polyethylene and polypropylene films, acrylic resin films, and the like, and polyolefin resin films and polyethylene. In a particular embodiment, the protective film is selected from the group composed of a terephthalate resin film and an acrylic resin film. When the optical film has two protective films, each protective film may be the same or different.

The thickness of the protective film is not particularly limited, but may be 10 to 120 μm, such as 15 to 110 μm, such as 20 to 100 μm. When the optical film has two protective films, the thickness of each protective film may be the same or different.

The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

Polyamide-imide material according to the present disclosure can be prepared according to a random type or controlled type procedure. In the random type procedure, all monomers and co-monomers are added to the reaction vessel prior to initiating the reaction. In the controlled type procedure, the reaction is initiated with a limited number of monomers and co-monomers and additional monomers and/or co-monomers are added at a later time.

The reaction temperature is not particularly limited and may be, for example, 5° C. to 200° C., and the reaction time is also not particularly limited, and may be, for example, about 30 minutes to 72 hours. In a particular embodiment of the invention, the reaction temperature is 5° C. to 200° C., such as 50° C. to 190° C., such as 100° C. to 180° C., and the reaction time may be 3 hours to 24 hours. In a particular embodiment, the reaction time is 5 hours to 20 hours.

In a particular embodiment, the reaction is carried out in a solvent. The solvent is not particularly limited as long as it does not affect the reaction, and for example, may include water, methanol, ethanol, ethylene glycol, isopropyl alcohol, propylene glycol, ethylene glycol methyl ether, ethylene glycol butyl ether, 1-methoxy-2-propanol, and the like, 2-alcohol solvents such as butoxyethanol and propylene glycol monomethyl ether; phenol solvents such as phenol and cresol; ethyl acetate, butyl acetate, ethylene glycol methyl ether acetate, γ-butyrolactone, γ-valerolactone, propylene glycol methyl ether acetate, ester solvents such as ethyl lactate; ketone solvents such as acetone, methyl ethyl ketone, cyclopentanone, cyclohexanone, 2-heptanone, methyl isobutyl ketone; aliphatic hydrocarbon solvents such as pentane, hexane and heptane; fats such as ethyl cyclohexane cyclic hydrocarbon solvent; aromatic hydrocarbon solvent such as toluene and xylene; nitrile solvent such as acetonitrile; ether solvent such as tetrahydrofuran and dimethoxyethane; chlorine-containing solvent such as chloroform and chlorobenzene; examples thereof include amide solvents such as N, N-dimethylformamide, N, N-dimethylacetamide; sulfur-containing solvents such as dimethyl sulfone, dimethyl sulfoxide and sulfolane; carbonate solvents such as ethylene carbonate and propylene carbonate; lactam solvents such as N-methyl-2-Pyrrolidinone; and combinations thereof. In a particular embodiment, the solvent may be a phenolic solvent and an amide solvent due to their desirable solubility.

In a particular embodiment of the present invention, the solvent used in the reaction may be a solvent that has been strictly dehydrated to a water content of 700 ppm or less. When such a solvent is used, it is easy to improve the optical properties, heat resistance and mechanical properties of the obtained optical film.

The reaction may be carried out under an inert atmosphere (nitrogen atmosphere, argon atmosphere, etc.) or a reduced pressure condition, if necessary, and may be performed in an inert atmosphere (nitrogen atmosphere, argon atmosphere, etc.). Below, it is desirable to carry out with stirring in a strictly controlled dehydration solvent. Under such conditions, it is easy to improve the obtained optical properties, heat resistance and mechanical properties.

The polyamide-imide resin may be isolated (separated and purified) by a conventional method, for example, a separation means such as filtration, concentration, extraction, crystallization, recrystallization, column chromatography, or a separation means combining these. In a particular embodiment, a large amount of an alcohol solvent such as methanol, ethanol, n-propanol, or isopropanol can be added to the reaction solution containing the resin to precipitate the resin, and the resin can be isolated by concentration, filtration, or drying.

### Experiment 1 (Standard Synthesis)-40/60-80/20 Composition

To a 1 L 4-neck round bottom flask equipped with nitrogen inlet and outlet, Vigreux reflux condenser, addition port, thermocouple, and overhead mechanical stirrer (with torque display), 4-aminophenyl-ethyl amine (APEA) (14.630 g, 107.42 mmol, 0.8 eq), 2,2′-Bis(trifluoromethyl)-benzidine (TFMB) (8.601 g, 26.853 mmol, 0.2 eq), 4,4′-(hexafluoroisopropylidene)diphthalic anhydride (6FDA) (23.862 g, 53.712 mmol, 0.4 eq), isoquinoline (0.57 g, 4.41 mmol, 0.08 eq relative to anhydride amount) and 240 mL n,n-dimethylacetamide (DMAc) were added. The flask was heated to 150° C. for 2 hours.

After two hours, the flask was allowed to cool to 70° C. 240 mL of DMAc was added, followed by Terephthaloyl chloride (TPC) (16.364 g, 80.603 mmol, 0.6 eq). After 1 hour, the flask was cooled to 50° C. Tricthylamine (TEA) (21.741 g, 214.85 mmol, 2 eq of TPC amount) was then added. After stirring for 1 h, the flask contents were precipitated into 4 L of EtOH/H₂O mixture. The precipitate was collected, blended in fresh EtOH/H₂O and filtered, producing a fine white colorless powder of the polyamide-imide (PAI).

The reaction was repeated with amounts of APEA, TFMB, 6FDA, and TPC adjusted according to Table 1.

When it comes to the preparation of a polyamide-imide film, a solvent cast approach can be used. Polyamide-imide material can be dissolved in a solvent at a concentration ranging from 1 to 30 weight percent, such as 5 to 25 weight percent, such as 10 to 20 weight percent to form a varnish. Examples of such a solvent include amide solvents such as N,N-dimethylacetamide (DMAc), N,N-diethylacetamide (DEAc), N,N-dimethylforamide (DMF), N.N-Dimethylisobutyramide, N,N-dimethylpropanamide, 3-methoxy-N,N-dimethylpropanamide (MDMPA); ketone solvents such as acetone, methyl ethyl ketone, cyclopentanone (CPN), cyclohexanone (CHN), acetophenone (PhAc), 2-heptanone, methylisobutyl ketone; lactone solvents such as γ-butyrolactone (GBL), γ-valerolactone; sulfur-containing solvents such as dimethylsulfone, dimethylsulfoxide and sulfolane; carbonate solvents such as ethylene carbonate and propylene carbonate; and combinations thereof. These solvents can be used alone or in combination of two or more. Further, the varnish may contain water, an alcohol solvent, an acyclic ester solvent, an ether solvent and the like.

The varnish can be coated on a flat surface such as a glass plate or a flexible carrier substrate and subsequently be dried. After the initial drying step, the film can be delaminated from the flat surface and further processed.

### Experiment 2-Preparation of Polyamide-imide Films

PAI films of the powders from Experiment 1 were prepared by first dissolving a portion of the powder in solvent (DMAc) at an approximate concentration of 10-20 wt % to produce a colorless viscous varnish. The varnish was then coated onto a glass substrate via doctor blade and heated at a temperature of 80° C. for 30 minutes to produce a ‘wet’ PAI film.

The film was then removed from the plate and mounted into a stainless steel frame and baked under vacuum at 250° C. for 12 hours, producing a dry, final colorless PAI film.

### Characterization of Polyamide-imide Films

Polymer films obtained using the method described in Experiment 2 were characterized for their optical, thermal and mechanical properties using the following methods:

Film thickness—The thickness of a polyamide-imide film was measured using a Mahr, 2057551 Marameter XLI-57B-15 Portable Thickness Gage. Typically, 6 to 21 measurements were taken across the film and the average value was reported.

Color and Optical Transparency—The optical properties (e.g. percent transmittance, color, haze, Rₜₕ) of a polyamide-imide film was measured using spectrophotometry. The percent transmittance of the polyamide-imide film was measured using a Shimadzu UV-2700 equipped with an integrating sphere (ISR-2600). Typically, films are inserted into a film sample holder and transmittance is measured from 800 nm to 200 nm using a slit width of 5 nm with the transmittance at 380 nm and 400 nm (T_{380%} and T_{400%}) reported. The color and haze of a polyamide-imide film was measured using an X-rite Ci7800 spectrophotometer. Typically, a film sample is placed in a 25 mm sample holder and a Class I continuous wave 532 nm laser is flashed through the sample to measure direct and total transmittance as well as haze. The average of three measurements is reported. Yellow index (YI) was measured according to ASTM E313-20. Haze was determined according to ASTM D1003-13. The Rₜₕ of a polyamide-imide film was measured using an Axometrics AxoScan™ Mueller Matrix Polarimeter according to ASTM F218-20. Typically, the film Rₜₕ is measured by taking two axis out-of-plane retardance measurements at 550 nm wavelength in increments of 10° up to a maximum tilt angle of 50°; several spots are measured per film and the lowest Rₜₕ value is reported.

Thermal properties—Incomplete imidization, residual solvent and thermal stability T_{d} (1%) were assessed using thermogravimetric analysis utilizing a TA Instruments Discovery TGA550. Typically, a few milligrams of polymer film are placed in a TGA pan which is heated at a rate of 10° C./min to 550° C. under a nitrogen purge of 40-60 mL/min. The temperature at which 1% mass loss is achieved is recorded as the T_{d} (1%); for dry films (i.e. fully imidized, no residual solvent) this would typically occur in the 375-450° C. temperature range for these materials. The glass transition (T_{g}) of a polyamide-imide film was measured using dynamic mechanical analysis utilizing a TA Instruments Discovery DMA850 equipped with a film/fiber accessory. Typically, a 5×30 mm sample is die punched and loaded into the film/fiber accessory clamp; the film is heated at 5° C./min rate to 350-400° C. in a nitrogen purged atmosphere under a 0.1% strain oscillated at 1 Hz. The glass transition measurement is determined from the onset of the drop in storage modulus and/or the tan δ maximum. The glass transition and coefficient of thermal expansion (CTE) of a polyamide-imide film was measured using thermal mechanical analysis utilizing a TA Instruments TMA Q400 with a film/fiber accessory. Typically, a 5×30 mm sample is used for testing. The sample is heated at 3° C./min to 350-400 ° C. under a nitrogen purge of 50 mL/min with a load of 0.5 g per film thickness in um. CTE can be calculated using the slope of the line between 100-200° C. The T_{g} is calculated by measuring the temperature at which elongation of the sample occurs.

Mechanical properties—The tensile modulus, tensile strength, and elongation at break were measured using an Instron 5967 with a 500 N load cell. Typically, the specimens are tested following ASTM 1708. The sample dimensions follow those listed in ASTM 1708 and thickness is measured for each film utilizing a Mahr GmbH 1086Ri 25/0, 0005 mm (1″/0.00002″). Measured force and sample displacement are used by the Instron to calculate the modulus, tensile strength, and elongation at break. Elongation at break was tested following ASTM D638-14 and tensile modulus via ASTM D638-14.

TABLE 1
Optical, mechanical, and thermal properties for films generated

| | | | | | | | | | Young | | |
|---|---|---|---|---|---|---|---|---|---|---|---|
| | | IV/ | Res. | T₃₈₀/ | T₄₀₀/ | Tₘₐₓ/ | | Haze | mod./ | EaB/ | |
| Composition | Ratio | dL/g | Sol./% | % | % | % | YI | H | GPa | % | T_{g}/° C. |
| 1 | 0.15/0.85- | 1.5 | 5 | 29 | 71.9 | 89.6 | 4 | 0.8 | 6.2 | 4.7 | ND |
| | 0.5/0.5 | | | | | | | | | | |
| 1 | 0.15/0.85- | 1.3 | 3.4 | 6 | 27.3 | 74.2 | ND | ND | 5.6 | 5 | ND |
| | 0.3/0.7 | | | | | | | | | | |
| 1 | 0.15/0.85- | 1.1 | 3.6 | 18 | 61.8 | 89.5 | 6.9 | 2.1 | 5.2 | 3.9 | ND |
| | 0.4/0.6 | | | | | | | | | | |
| 1 | 0.175/ | 1.4 | 3 | 33.8 | 70.1 | 89.2 | 5.7 | 2.4 | 6.1 | 6.3 | ND |
| | 0.825- | | | | | | | | | | |
| | 0.35/0.65 | | | | | | | | | | |
| 1 | 0.2/0.8- | 1 | 2 | 20.7 | 63.1 | 89.5 | 6.3 | 0.2 | 5.7 | 6.8 | ND |
| | 0.5/0.5 | | | | | | | | | | |
| 1 | 0.2/0.8- | 0.7 | 2.3 | 22 | 61.5 | 83 | 4.5 | 0.7 | 6.3 | 6.8 | ND |
| | 0.6/0.4 | | | | | | | | | | |
| 1 | 0.2/0.8- | 1.3 | 2.5 | 32 | 60.5 | 88.5 | 8.5 | 5.4 | 6.4 | 5.7 | ND |
| | 0.3/0.7 | | | | | | | | | | |
| 1 | 0.2/0.8- | 1.4 | 2.9 | 37.7 | 76.8 | 89.8 | 2.4 | 0.5 | 6.3 | 8.7 | 289.5 |
| | 0.4/0.6 | | | | | | | | | | |
| 1 | 0.25/0.75- | 1.1 | 3.1 | 26.3 | 64.8 | 89.5 | 6.9 | 0.6 | 5.8 | 6 | 240 |
| | 0.25/0.75 | | | | | | | | | | |
| 1 | 0.25/0.75- | 1.3 | 2.3 | 33.1 | 73.2 | 89.7 | 4.1 | 0.4 | 6 | 11.7 | 272 |
| | 0.5/0.5 | | | | | | | | | | |
| 1 | 0.3/0.7- | 1 | 2.5 | 28.9 | 74.2 | 90 | 2.9 | 0.3 | 5.3 | 14.8 | ND |
| | 0.6/0.4 | | | | | | | | | | |
| 1 | 0.3/0.7- | 0.9 | 6.9 | 21.2 | 74.2 | 90 | 2.6 | 1.7 | 4.6 | 6.5 | ND |
| | 0.8/0.2 | | | | | | | | | | |
| 1 | 0.4/0.6- | 0.9 | 2.3 | 22.1 | 72.7 | 90.2 | 2.8 | 1 | 4.6 | 9.4 | ND |
| | 0.8/0.2 | | | | | | | | | | |
| 2 | 0.2/0.8- | ND | 2.8 | ND | ND | ND | 6.4 | 0.1 | 6.2 | 7.4 | ND |
| | 0.4/0.6 | | | | | | | | | | |

Composition 1: 6FDA/TPC—APEA/TFMB, Composition 2: 6FDA/TPC—APPA/TFMB, Ratio—molar ratio of monomers; IV—intrinsic viscosity; res. sol.—residual solvent; T₃₈₀—transmittance at 380 nm; T₄₀₀—transmittance at 400 nm; Tₘₐₓ—maximum transmittance (˜550 nm); YI—yellow index; H—Haze; Young's modulus; T_{g}—glass transition temperature.

Experiment 3-To a reactor equipped with nitrogen inlet and outlet, reflux condenser, addition port, thermocouple, and overhead mechanical stirrer, 4-aminophenyl-ethyl amine (APEA) (1.158 kg), 4,4′-(hexafluoroisopropylidene)diphthalic anhydride (6FDA) (1.888 kg), isoquinoline (0.082 kg) and N,N-dimethylacetamide (DMAc) (44.85 kg) were added. The reactor was heated to 120° C. for 16 hours, and the reactor was allowed to cool to 70° C. 2,2′-bis(trifluoromethyl)-benzidine (TFMB) (4.083 kg), tricthylamine (TEA) (3.440 kg), DMAc (37.83 kg) were added, followed by terephthaloyl chloride (TPC) (3.458 kg). After 1 hour, the reactor was cooled to 20° C., and methanol (248.06 kg) was added. The resulting precipitate was filtered, and washed with methanol 5 times, and dried in an oven at 114° C. for 12 hours. A powder of the polyamide-imide (PAI) was obtained (8.2 kg). The weight average molecular weight(Mw) of the obtained PAI was 157,000.

Experiment 4-To a reactor equipped with nitrogen inlet and outlet, reflux condenser, addition port, thermocouple, and overhead mechanical stirrer, 4-aminophenyl-ethyl amine (APEA) (2.724 g), 4,4′-(hexafluoroisopropylidene)diphthalic anhydride (6FDA) (4.442 g), isoquinoline (0.194 g) and N-methylpyrrolidone (NMP) (105.54 g) were added. The reactor was heated to 150° C. for 4 hours, and the reactor was allowed to cool to 10° C. 2,2′-bis(trifluoromethyl)benzidine (TFMB) (9.607 g), tricthylamine (TEA) (8.095 g), NMP (26.39 g) were added, followed by terephthaloyl chloride (TPC) (7.309 g). After 1 hour, NMP (62.63 g) was added, the reactor was heated to 70° C., and TPC (0.827 g) was added. After 1 hour, the reactor was cooled to 20° C., and methanol (583.67 g) was added. The resulting precipitate was filtered, and washed with methanol 3 times, and dried in an oven at 140° C. for 12 hours. A powder of the polyamide-imide (PAI) was obtained (19.31 g). The weight average molecular weight(Mw) of the obtained PAI was 334,000.

### Weight Average Molecular Weight (Mw)

The weight average Molecular Weight (Mw) and number average molecular weight (Mn) of the polyamide-imide resins obtained in Examples and Comparative Examples were measured by using GPC under the following conditions:

### (GPC Condition)

Equipment: Shimadzu LC-20A
Column: TSKgel GMHHR-M (Mix column, exclusion limit molecular weight: 4 million)
   Guard column: TSK gel guard column HHR-H
   Mobile phase: N-methyl-2-pyrrolidinone (NMP) 10 mM LiBr added
   * NMP uses HPLC grade, LiBr uses first-class reagent (anhydride)
   Flow velocity: 1 mL/min
   Measurement time: 20 minutes
   Column oven: 40° C.
   Detection: UV 275 nm
   Cleaning solvent: NMP
   Sample concentration: 1 mg/mL (20 wt % reaction mass diluted to 5 mg/mL in mobile phase for analysis)
   Molecular Weight Calibration: Standard Polystyrene from Polymer
   Laboratories (17 molecular weights with a molecular weight of 5-4 million)

### Optical Film

Example 3-The obtained PAI resin was dissolved in N,N-diethylacetamide (DEAc) so that the solid content concentration was 11% by mass, and 3 phr of Sumisorb 340 was added as an ultraviolet absorber (UVA) to prepare a varnish. Then, the obtained varnish was applied to PET substrate, heated at 100° C. for 15 minutes, and at 120° C. for 7 minutes, then further heated at 140° C. for 15 minutes, and peeled off from the PET substrate. The peeled off film was dried in an oven at 200° C. for 40 minutes to obtain an optical film having a thickness of 50 μm. The amount of residual solvent in the obtained optical film was 2.07% by mass.

Example 4-The obtained PAI resin was dissolved in N,N-dimethylacetamide (DMAc) so that the solid content concentration was 12% by mass, and 30% of silica (particle size: 12 nm) and 3 phr of Sumisorb 340 was added to prepare a varnish. Then, the obtained varnish was applied to PET substrate, heated at 100° C. for 15 minutes, and at 120° C. for 7 minutes, then further heated at 140° C. for 15 minutes, and peeled off from the PET substrate. The peeled off film was dried in an oven at 200° C. for 30 minutes to obtain an optical film having a thickness of 50 μm.

### Compressive Modulus

The compressive modulus was measured using an iMicro (KLA) with a Berkovich indenter. Typically, the specimens are tested following ISO 14577-1. The sample dimensions and measurement conditions were as follows;
Sample dimensions: 1 cm×1 cm×1 cm
   Measurement load: 30 mN
   Load application time: 15 sec
   Load holding time: 60 sec
   Poisson coefficient: 0.35
   Number of measurement: 9 points

TABLE 2
Optical, mechanical, and thermal properties for films generated

| | | | Res. | | | | YI D | | | Young | | | Compressive |
|---|---|---|---|---|---|---|---|---|---|---|---|---|---|
| | | IV/ | Sol./ | T₃₈₀/ | T₄₀₀/ | Tₘₐₓ/ | (Take | | Haze | mod./ | EaB/ | T_{g}/ | mod./ |
| Example | Ratio | dL/g | % | % | % | % | out) | YI | H | GPa | % | ° C. | GPa |
| 3 | 0.2/0.8- | ND | 2.07 | 2.6 | 71.9 | 90.0 | ND | 3.3 | 0.1 | 6.0 | ND | ND | 5.1 |
| | 0.4/0.6 | | | | | | | | | | | | |
| 4 | 0.2/0.8- | ND | ND | ND | ND | 89.6 | ND | 1.9 | 0.2 | ND | ND | ND | 7.5 |
| | 0.4/0.6 | | | | | | | | | | | | |

What is claimed is:

1. A polyamide-imide material comprising a moiety of Formula (I) or (II): 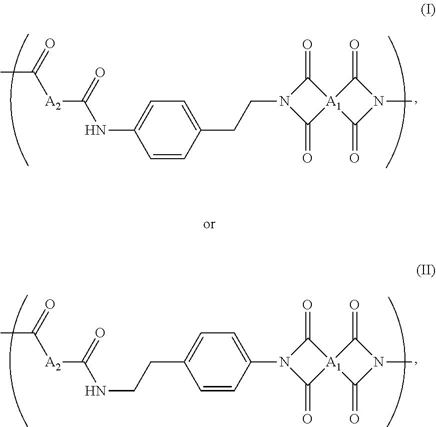
wherein A₁ is selected from a group of tetravalent moieties and A₂ is selected from a group of divalent moieties;
wherein the polyamide-imide material has at least one property selected from the following property group M and at least one property selected from the following property group O, wherein property group M comprises:
(i) a tensile modulus of the polyamide-imide material as determined according to ASTM standard D638-14 of at least 3.5 GPa, at least 3.8 GPa, at least 4.0 GPa, at least 4.3 GPa, at least 4.5 GPa, at least 4.8 GPa, at least 5.0 GPa, at least 5.3 GPa, at least 5.5 GPa, at least 5.8 GPa, at least 6.0 GPa, at least 6.3 GPa, at least 6.5 GPa, at least 6.8 GPa, at least 7.0 GPa, at least 7.3 GPa, at least 7.5 GPa, or at least 7.8 GPa;
(ii) a glass transition temperature of the polyamide-imide material as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 50 kDa, at least 100 kDa, at least 150 kDa, at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa. or a weight average molecular weight as determined by size exclusion chromatography against a polystyrene standard of at least 50 k, at least 100 k, at least 150 k, or at least 200 k;
(iv) an elongation at break of a film having a thickness of 25 micrometer (±5 micrometer) of the polyamide-imide material as determined by ASTM D638-14 of not more than 15%, not more than 14%, not more than 13%, not more than 12%, not more than 11%, not more than 10%, not more than 9%, not more than 8.5%, not more than 8%, not more than 7.5%, not more than 7%, not more than 6.5%, not more than 6%, not more than 5.5%, not more than 5%, or not more than 4.5%;
(v) a folding endurance of a film having a thickness of 25 micrometer (±5 micrometer) of the polyamide-imide material as determined according to ASTM D2176-16 over a pin having a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds; or
(vi) a compressive modulus of the polyamide-imide material as determined according to ISO 14577-1 of at least 5.0 GPa, at least 5.5 GPa, at least 6.0 GPa, at least 6.5 GPa, at least 7.0 GPa, or at least 7.5 GPa; and
property group O comprises:
(i) an optical transparency of a film having a thickness of 25 micrometer (±5 micrometer) of the polyamide-imide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyamide-imide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyamide-imide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) an optical thickness retardation Rₜₕ according to ASTM F218-20 of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASTM E313-20 of a film having a thickness of 25 micrometer (±5 micrometer) of the polyamide-imide material of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze as determined according to ASTM D1003-13 of a film having a thickness of 25 micrometer (±5 micrometer) of the polyamide-imide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

2. The polyamide-imide material according to claim 1, wherein A₁ is selected from:

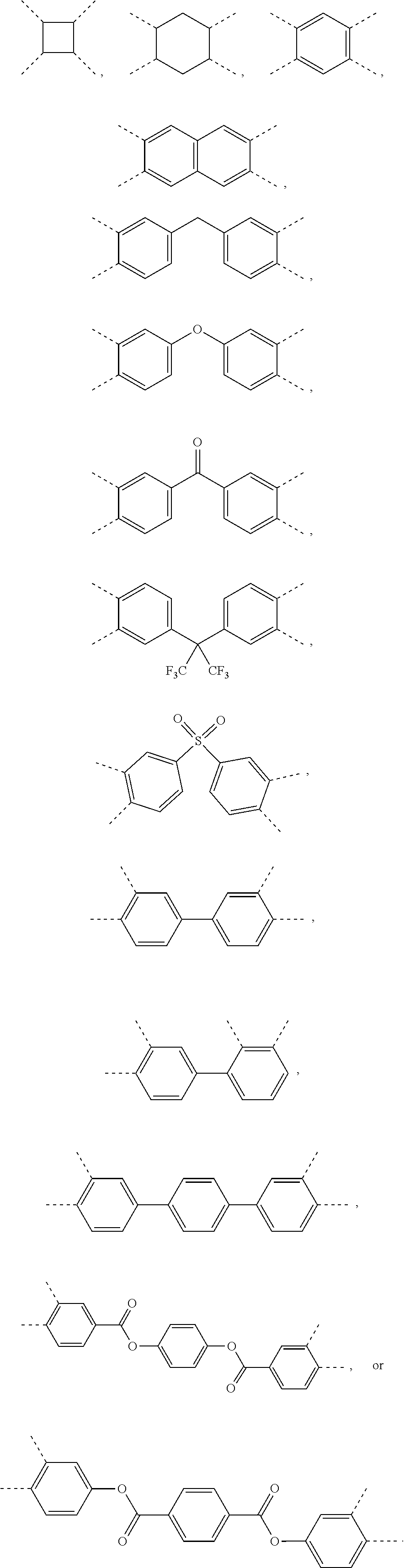

3. The polyamide-imide material according to claim 2, wherein A₁ is selected from the group consisting essentially of:

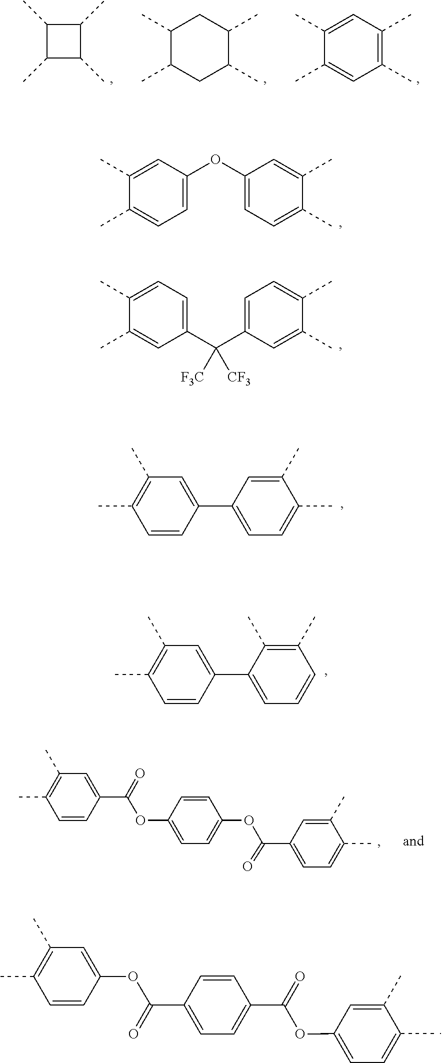

4. The polyamide-imide material according to claim 1, wherein A₂ is selected from:

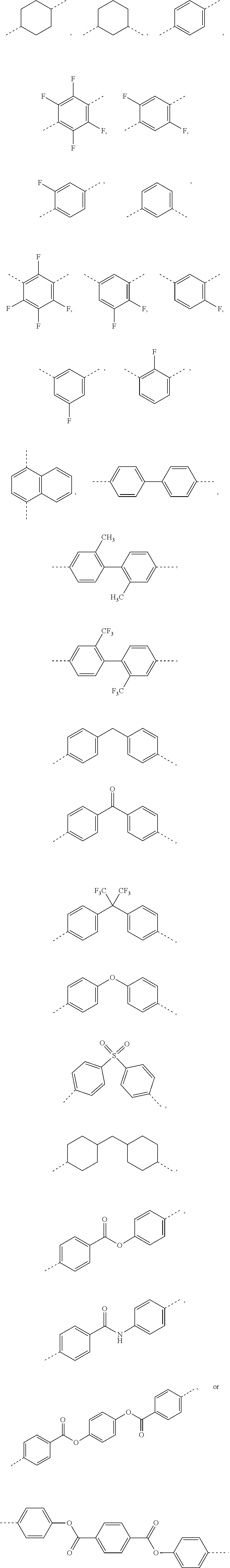

5. The polyamide-imide material according to claim 4, wherein A₂ is selected from the group consisting of:

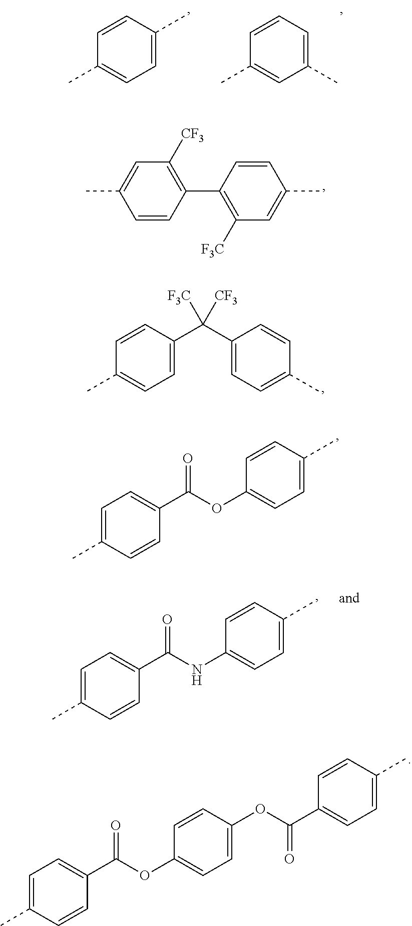

6. The polyamide-imide material according to claim 1, having at least two, at least three, or at least four properties of property group M.

7. The polyamide-imide material according to claim 1, having at least two, at least three, or at least four properties of property group O.

8. An optical film comprising a polyamide-imide material according to claim 1.

9. An optical film comprising a polyamide-imide material and filler include inorganic particles according to claim 1.

10. An optical stack comprising a polyamide-imide material according to claim 1.

11. An electronic device comprising a polyamide-imide material according to claim 1.

12. A polyamide-imide made from a first monomer comprising Formula (III): 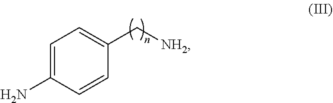
wherein n is 1, 2, or 3; and at least one second monomer selected from the group consisting of 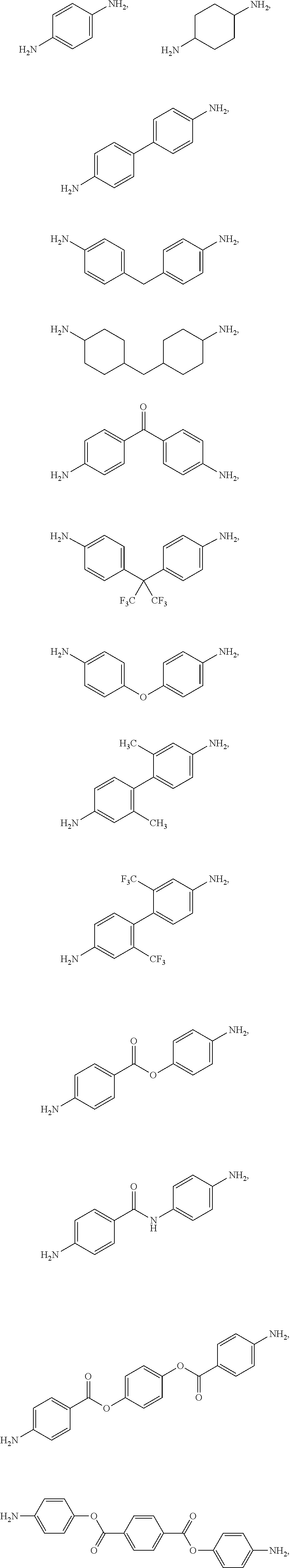
and any suitable derivatives thereof;
at least one tetravalent co-monomer selected from the group consisting of: 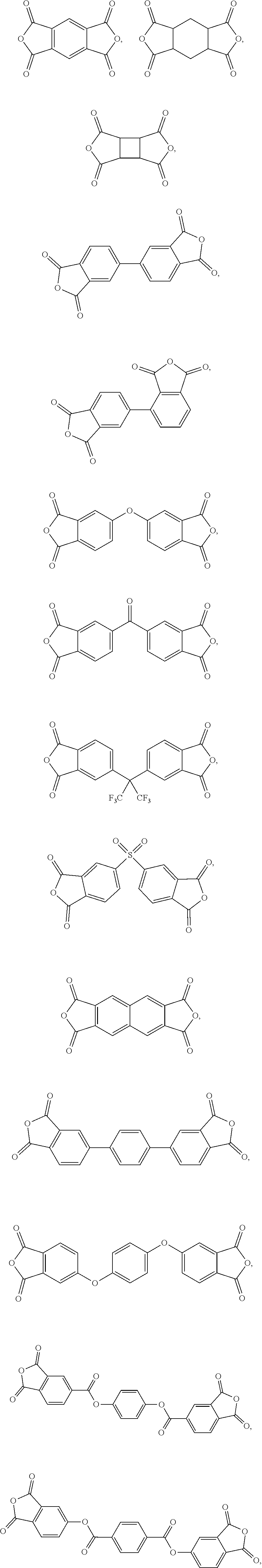
and any suitable derivatives thereof; and
at least one divalent co-monomer selected from the group consisting of: 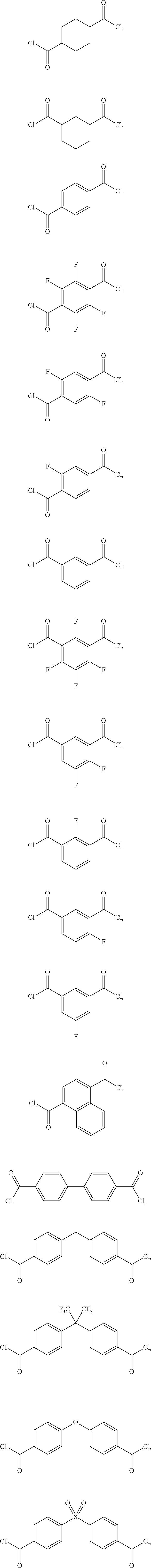
and any suitable derivative thereof.

13. The polyamide-imide according to claim 12, wherein the first and the second monomer are in a molar ratio ranging from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

14. The polyamide-imide according to claim 12 , wherein the tetravalent co-monomer and the divalent co-monomer are in a molar ratio ranging from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

15. The polyamide-imide according to claim 12, wherein the first monomer is

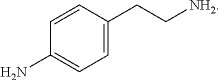

16. The polyamide-imide according to claim 12, wherein the tetravalent co-monomer is selected from 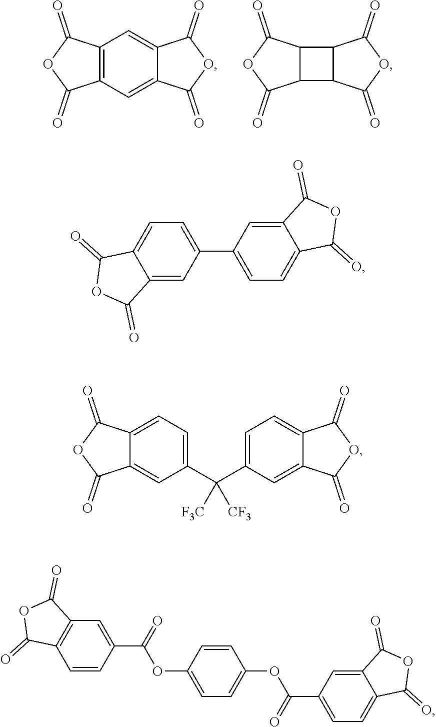
or any suitable derivative thereof;
wherein the divalent co-monomer is selected from 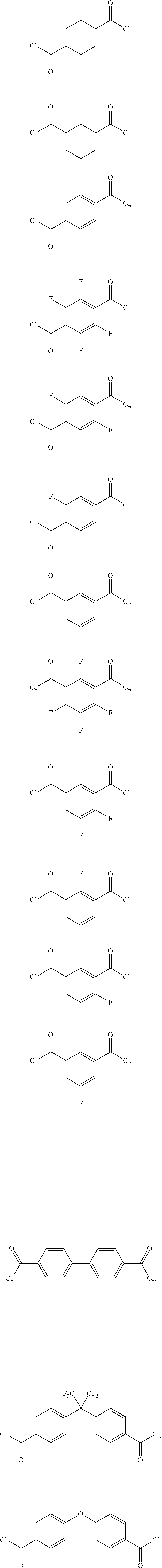
and any suitable derivative thereof.

17. The polyamide-imide according to claim 12, wherein the first monomer is 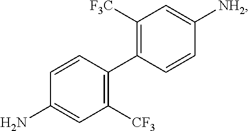 [SMILES: Nc1ccc(-c2ccc(N)cc2C(F)(F)F)c(C(F)(F)F)c1]
the second monomer is 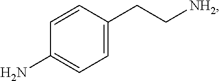
the tetravalent co-monomer is 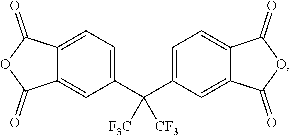 [SMILES: O=C1OC(=O)c2cc(C(c3ccc4c(c3)C(=O)OC4=O)(C(F)(F)F)C(F)(F)F)ccc21]
and the divalent co-monomer is

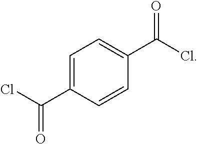 [SMILES: O=C(Cl)c1ccc(C(=O)Cl)cc1]

18. The polyamide-imide according to claim 17, wherein the first monomer and the second monomer are in a molar ratio ranging from 1:2 to 2:1 and the tetravalent co-monomer to the divalent co-monomer is in a molar ratio of 1:5 to 5:1.

19. A polyamide-imide material comprising Formula (IV) 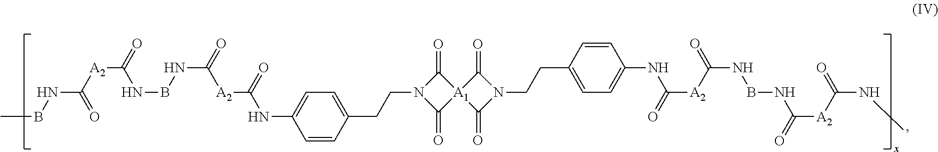
wherein A₁ is selected from a group of tetravalent moieties, A₂ is selected from a first group of divalent moieties and B is selected from a second group of divalent moieties, wherein x is an integer greater than 1.

20. The polyamide-imide material according to claim 19, having at least one property selected from the following property group M and at least one property selected from the following property group O, wherein property group M comprises:
(i) a tensile modulus of the polyamide-imide material as determined according to ASTM standard D638-14 of at least 3.5 GPa, at least 3.8 GPa, at least 4.0 GPa, at least 4.3 GPa, at least 4.5 GPa, at least 4.8 GPa, at least 5.0 GPa, at least 5.3 GPa, at least 5.5 GPa, at least 5.8 GPa, at least 6.0 GPa, at least 6.3 GPa, at least 6.5 GPa, at least 6.8 GPa, at least 7.0 GPa, at least 7.3 GPa, at least 7.5 GPa, or at least 7.8 GPa;
(ii) a glass transition temperature of the polyamide-imide material as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 50 kDa, at least 100 kDa, at least 150 kDa, at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa, or a weight average molecular weight as determined by size exclusion chromatography against a polystyrene standard of at least 50 k, at least 100 k, at least 150 k, or at least 200 k;
(iv) an elongation at break of a film having a thickness of 25 micrometer (±5 micrometer) of the polyamide-imide material as determined by ASTM D638-14 of not more than 15%, not more than 14%, not more than 13%, not more than 12%, not more than 11%, not more than 10%, not more than 9%, not more than 8.5%, not more than 8%, not more than 7.5%, not more than 7%, not more than 6.5%, not more than 6%, not more than 5.5%, not more than 5%, or not more than 4.5%;
(v) a folding endurance of a film having a thickness of 25 micrometer (±5 micrometer) of the polyamide-imide material as determined according to ASTM D2176-16 over a pin having a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds; or
(vi) a compressive modulus of the polyamide-imide material as determined according to ISO 14577-1 of at least 5.0 GPa, at least 5.5 GPa, at least 6.0 GPa, at least 6.5 GPa, at least 7.0 GPa, or at least 7.5 GPa; and
property group O comprises:
(i) an optical transparency of a film having a thickness of 25 micrometer (±5 micrometer) of the polyamide-imide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyamide-imide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyamide-imide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) an optical thickness retardation Rₜₕ according to ASTM F218-20 of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASTM E313-20 of a film having a thickness of 25 micrometer (±5 micrometer) of the polyamide-imide material of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze as determined according to ASTM D1003-13 of a film having a thickness of 25 micrometer (±5 micrometer) of the polyamide-imide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

21. The polyamide-imide material according to claim 19, wherein A₁ is selected from:

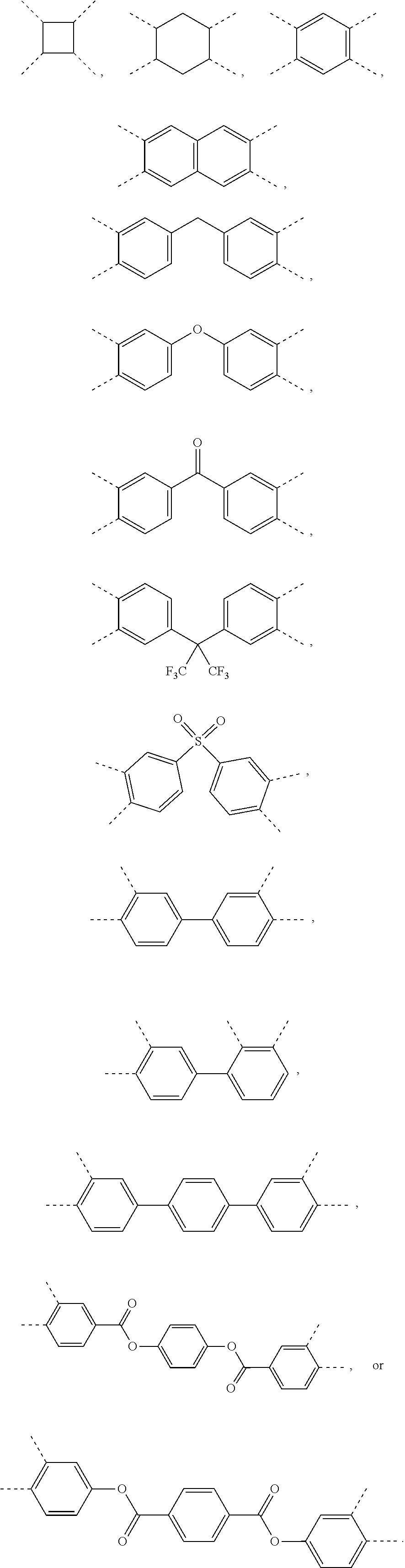

22. The polyamide-imide material according to claim 19, wherein A₂ is selected from:

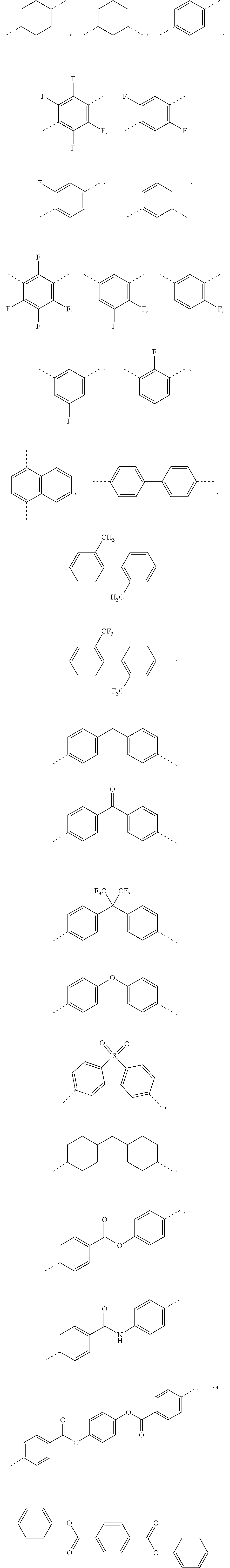

23. The polyamide-imide material according to claim 19, wherein B is selected independently for each occasion from:

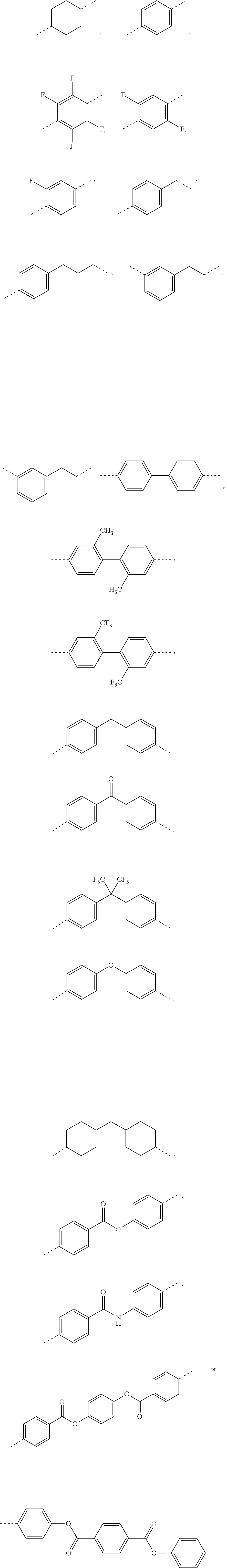

24. The polyamide-imide material according claim 19, having at least two, at least three, or at least four properties of property group M or having at least two, at least three, or at least four properties of property group O.
